(19) United States
(12) Patent Application Publication
(10) Pub. No.: US 2005/0171811 A1
(43) Pub. Date: Aug. 4, 2005

(54) Electronic financial transaction system

(75) Inventors: Eric Campbell, Rye, NH (US); Robert F. Hoffman, Baldwin, NY (US); Eve Renee Nebenhaus, Manhasset, NY (US); Maris N. Lemanis, Smithtown, NY (US)

Correspondence Address: TIMOTHY P. O'HAGAN, 8710 KILKENNY CT, FORT MYERS, FL, 33912, US

(73) Assignee: Bottomline Technologies (DE) Inc., Portsmouth, NH (US)

(21) Appl. No.: 11/057,713

(22) Filed: Feb. 14, 2005

Related U.S. Application Data
(63) Continuation-in-part of application No. 09/670,266, filed on Sep. 26, 2000, now Pat. No. 6,856,970.

(51) Int. Cl. G06F 17/60

(52) U.S. Cl. 705/1

(57) ABSTRACT

A financial transaction system manages the exchange of financial transaction data between a client system coupled to the financial transaction system by an open network and a financial institution transaction processing system. The financial transaction system comprises a web server coupled to the open network for receiving a financial transaction from the client system. The financial transaction is in user group transaction format and comprises a plurality of data elements, at least a portion of the data elements comprise sub elements. A hub loading receives the financial transaction in the user group transaction format and parses the financial transaction to a core data element format compliant with a transaction type profile corresponding to the financial transaction. An application loading module receives the financial transaction in the core data element format and generates a financial transaction in an application format. The application format comprises a plurality of application data elements different than the data elements. A hub application receives the financial transaction in the application format, groups the financial transaction in the application format with a plurality of other financial transactions in the application format to create a batch transaction file, and provides the batch transaction file to the financial institution transaction processing system.

### CROSS REFERENCE TO RELATED APPLICATIONS

The present application is a continuation in part of U.S. patent application Ser. No. 09/670,266, filed on Sep. 26, 2000, entitled Electronic Financial Transaction System.

### FIELD OF THE INVENTION

The present invention relates to a system and method for electronic financial transactions, and more particularly, to a web browser-based system for the execution of transactions by clients of a financial institution.

### BACKGROUND OF THE INVENTION

Corporate and individual clients of banks and other financial institutions have traditionally accessed the electronic cash management systems of their banks by phone, fax, or dumb terminal at the low end of the service spectrum, and by Microsoft Windows™ or DOS-based workstations at the high end. Recently, there has been an increase in the popularity of banking on the World Wide Web, as more and more businesses and individuals are recognizing the benefits of performing online transactions over the ever-growing internet. With the recent explosion in e-commerce, the increasing acceptance of the Internet as a less expensive and more efficient way of doing business, and the advent of new server technology and sophisticated online security systems, online banking by both businesses and individuals is becoming ever more common. Banks desiring to stay competitive must therefore provide to their clients internet-based electronic cash management (ECM) services. According to a 1997 research study, most banks predicted that within a year they would be providing browser-based electronic banking services to their corporate and institutional clients. Despite the increased customer demand for such services, less than 2% of banking services were provided via a web browser, according to research in 1999. It has been predicted that by 2005, electronic transaction-based cash management revenue will reach $12.8 billion.

One hurdle to implementing unified browser-based ECM has been the wide range of hardware and software systems used by financial institutions. Even within a single financial institution, multiple hardware and software systems have made integration difficult. During the microcomputer revolution of the early 1980s, in which computers started becoming smaller, faster and less expensive, financial institutions raced to install “treasury workstations” into their top clients' offices, resulting in enormous outlays. The treasury workstations included terminals or microcomputers directly linked to back office systems in the corresponding financial institution, so that clients of the financial institutions could perform many banking and other financial transactions on-site. Such workstations performed functions such as corporate funds transfer, international funds transfer, balance and transaction reporting, securities management, and bank relationship management. Toward the late 1980s, banks and other financial institutions became unable to justify the huge expense of developing and re-developing these treasury workstations, which, although a boon to their clients, did not directly increase the revenue of the financial institutions. Thus, in order to increase their own business, the financial institutions ended up buying, borrowing, and developing new workstations focused on increasing the volume of bank core transactions, including elaborate PC front ends for funds transfer, letters of credit, securities, commercial paper, FX, and account reporting. Some of the larger financial institutions ended up with many different systems, each performing similar or identical functions. The new workstations included, for example, “letter of credit” workstations, “commercial paper issuance” workstations, “custody” workstations, and “balance and transaction reporting” workstations. Despite the availability of these new workstations, however, many financial institutions and their clients continued to use the older treasury workstations, often still using dumb terminal systems developed in the late 1970s and early 1980s. The decentralization of client-delivery systems was deliberate and resulted in speed-to-market advantages. Unfortunately, costs were now escalating due to duplication of development and support organizations. Moreover, clients ended up with many different systems, passwords and technologies just to deal with the same financial institution, whereby the financial institution appeared disorganized and fragmented to the client. There is thus a need to integrate multiple data sources and a variety of workstation technologies, platforms and communications methods into a single point of access for the financial institution client.

### SUMMARY OF THE INVENTION

A first aspect of the present invention is to provide a financial transaction system for managing the exchange of financial transaction data between a client system coupled to the financial transaction system by an open network and a financial institution transaction processing system.

The financial transaction system comprises a web server coupled to the open network for receiving a financial transaction from the client system in the user group transaction format. The financial transaction comprising a plurality of data elements—with a least a portion of the data elements comprising sub elements. The web server writes the financial transaction to a queue database or message queue of the hub database in association with an indication that the message is queued for hub loading.

A hub loading module retrieves the financial transaction, in the user group transaction format, from the message queue, parses the financial transaction to a core data element format compliant with a transaction type profile of the financial transaction, and writes the financial transaction, in the core data element format, to the message queue in association with an indication that the message is queued for application loading.

An application loading module retrieves the financial transaction from the message queue and generates a financial transaction in an application format and writes the application format transaction to an application database. The application format comprises a plurality of application data elements that different than the data elements of the user group transaction format. The application database comprises tables configured for operation with a hub application.

A hub application manipulates application data within the application database and, more specifically in one aspect of the present invention: i) receives the financial transaction in the application format; ii) groups the financial transaction in the application format with a plurality of other financial transactions in the application format to create a batch transaction file; and iii) provides the batch transaction file to the financial institution transaction processing system.

In a sub embodiment of the present invention, the application database associates, with the financial transaction, information about the processing status of the financial transaction. In this sub embodiment, the hub application writes information about the processing status of the financial transaction to the application database upon grouping of the financial transaction into a batch transaction file.

In another sub embodiment of the present invention, the hub application utilizes the financial transaction data elements to generate an approval inquiry transaction related to the financial transaction. The approval inquiry transaction includes only a portion of the data elements of the financial transaction and additional data elements related to approval of the financial transaction for processing. The hub application further: i) queues the approval transaction for delivery to a member of a user group with authority to approve processing of the financial transaction; and ii) groups the financial transaction with a plurality of other financial transactions to create a batch transaction file for providing to the financial institution transaction processing system only after receiving an approval response transaction in response to the generated approval inquiry transaction.

In this sub embodiment, the application database associates, with the financial transaction, information about the processing status of the financial transaction and the hub application writes information about the processing status of the financial transaction to the application database upon receiving an approval response.

In another sub embodiment, the hub application may further receive a batch response file from the financial institution transaction processing system. Upon receipt of a batch response file, the hub application: i) extracts a response transaction from the batch response file; and ii) writes the response transaction to the queue database in association with an indication of the user group and an indication that an extraction module is the destination of the response transaction.

An extraction module: i) receives the response transaction from the queue database; ii) generates a user group response transaction in a format associated with the response transaction type and transaction requirements of the user group; and iii) writes the user group response transaction to the queue database in association with an indication that the user group is the destination of the response transaction.

The web server retrieves the response transaction from the queue database and either: i) populates data elements of the response transaction into a web document and provides the web document to a client system operated by a member off the user group; or ii) populates data elements of the response into a response file comprising data elements of multiple response transactions for delivery to a member of the user group, and provides the response file to a client system operated by a member off the user group.

### BRIEF DESCRIPTION OF THE DRAWINGS

FIG. 1 is a system-wide view of one embodiment of a financial transaction system in accordance with one embodiment of the present invention;

FIG. 2 is block diagram representing a hub database in accordance with one embodiment of the present invention;

FIG. 3 is a block diagram representing a hub server in accordance with one embodiment of the present invention;

FIG. 4 is a block diagram representing a loading module in accordance with one embodiment of the present invention;

FIG. 5 is a block diagram representing a loading process in accordance with one embodiment of the present invention;

FIG. 6 is a block diagram representing an extraction module in accordance with one embodiment of the present invention;

FIG. 7 is a diagram representing a main menu of a menu driven work flow application in accordance with one embodiment of the present invention;

FIG. 8 is a diagram representing a document comprising a menu of data recipient reports in accordance with one embodiment of the present invention;

FIG. 9 is a diagram representing an document comprising an exemplary data recipient report in accordance with one embodiment of the present invention;

FIG. 10 is a diagram representing an document comprising an exemplary data recipient report in accordance with one embodiment of the present invention;

FIG. 11 is a diagram representing an document comprising an exemplary data recipient report in accordance with one embodiment of the present invention;

FIG. 12 is a diagram representing an document comprising an exemplary data recipient report in accordance with one embodiment of the present invention;

FIG. 13 is a diagram representing a graphical user interface sort control in accordance with one embodiment of the present invention;

FIG. 14 is a diagram representing a document comprising controls for entry of financial transaction data in accordance with one embodiment of the present invention;

FIG. 15 is a diagram representing a document comprising an approval inquiry transaction and control for entry of an approval transaction in accordance with one embodiment of the present invention;

FIG. 16 is a diagram representing a document comprising controls for entry and/or extraction of transaction data in a file format in accordance with one embodiment of the present invention;

FIG. 17 is a diagram representing a document comprising controls for storage of transaction data in a file format in accordance with one embodiment of the present invention;

FIG. 18 is a diagram representing a document comprising acknowledgment of entry of transaction data in a file format in accordance with one embodiment of the present invention;

FIG. 19 is a diagram representing a document comprising controls for entry and/or extraction of transaction data in a file format in accordance with one embodiment of the present invention;

FIG. 20 is a diagram representing a document comprising user ID maintenance controls in accordance with one embodiment of the present invention;

FIG. 21 is a diagram representing a document comprising security group maintenance controls in accordance with one embodiment of the present invention;

FIG. 22 is a block diagram representing an exemplary security group control configuration in accordance with one embodiment of the present invention;

FIG. 23 is a block diagram representing an exemplary security group control configuration in accordance with one embodiment of the present invention;

FIG. 24 is a block diagram representing an exemplary security group control configuration in accordance with one embodiment of the present invention;

FIG. 25 is a block diagram representing an exemplary security group control configuration in accordance with one embodiment of the present invention;

FIG. 26 is a block diagram representing an exemplary security group control configuration in accordance with one embodiment of the present invention;

FIG. 27 is a flow diagram representing exemplary operation of the financial transaction system in accordance with one embodiment of the present invention;

FIG. 28 is a flow diagram representing the flow of transactions and approval thereof in accordance with one embodiment of the present invention;

FIG. 29 is a diagram representing a data table useful for operation of the financial transaction system in accordance with one embodiment of the present invention;

FIG. 30 is a diagram representing a data table useful for operation of the financial transaction system in accordance with one embodiment of the present invention;

FIG. 31 is a diagram representing a data table useful for operation of the financial transaction system in accordance with one embodiment of the present invention;

FIG. 32 is a diagram representing a data table useful for operation of the financial transaction system in accordance with one embodiment of the present invention;

FIG. 33 is a diagram representing a data table useful for operation of the financial transaction system in accordance with one embodiment of the present invention;

FIG. 34 is a diagram representing a data table useful for operation of the financial transaction system in accordance with one embodiment of the present invention; and

FIG. 35 is a diagram representing a table of audit events useful for operation of the financial transaction system in accordance with one embodiment of the present invention;

### DETAILED DESCRIPTION

It will be appreciated by those skilled in the art that although the following Detailed Description will proceed with reference being made to preferred embodiments, the present invention is not intended to be limited to these embodiments. For example, it should be understood from the outset that although preferably the functional components of the preferred embodiments of the system of the present invention are embodied as one or more distributed computer program processes, data structures, dictionaries or other stored data on one or more conventional general purpose computers (e.g. IBM-compatible, Apple Macintosh, and/or RISC microprocessor-based computers), mainframes, minicomputers, conventional telecommunications (e.g. modem, DSL, satellite and/or ISDN communications), memory storage means (e.g. RAM, ROM) and storage devices (e.g. computer-readable memory, disk array, direct access storage) networked together by conventional network hardware and software (e.g. LAN/WAN network backbone systems and/or Internet), other types of computers and network resources may be used without departing from the present invention.

The invention as described herein may be embodied in a computer residing on a network transaction server system, and input/output access to the invention may comprise appropriate hardware and software (e.g. personal and/or mainframe computers provisioned with Internet wide area network communications hardware and software (e.g. CQI-based, FTP, Netscape Navigator™ or Microsoft Internet Explorer™ HTML Internet browser software, and/or direct real-time TCP/IP interfaces accessing real-time TCP/IP sockets) for permitting human users to send and receive data, or to allow unattended execution of various operations of the invention, in real-time and/or batch-type transactions. Likewise, it is preferred that the system of the present invention be a remote internet-based server accessible through conventional communications channels (e.g. conventional telecommunications, broadband communications, wireless communications) using conventional browser software (e.g. Netscape Navigator™ or Microsoft Internet Explorer™). Thus, the present invention is preferably appropriately adapted to include such communication functionality and internet browsing ability. Additionally, those skilled in the art will recognize that the various components of the server system of the present invention can be remote from one another, and may further comprise appropriate communications hardware/software and/or LAN/WAN hardware and/or software to accomplish the functionality herein described.

Preferably, each of the functional components of the present invention are embodied as one or more distributed computer program processes running on one or more conventional general purpose computers networked together by conventional networking hardware and software. Most preferably, each of these functional components is embodied by running distributed computer program processes (e.g., generated using “full-scale” relational database engines such as IBM DB2™, Microsoft SQL Server™, Sybase SQL Server™, Oracle 7.3™, or Oracle 8.0™ database managers, and/or a JDBC interface to link to such databases) on networked computer systems (e.g. comprising mainframe and/or symmetrically or massively parallel computing systems such as the IBM SB2™ or HP 9000™ computer systems) including appropriate mass storage, networking, and other hardware and software for permitting these functional components to achieve the stated function. Preferably, these computer systems are geographically distributed and connected together via appropriate wide- and local-area network hardware and software. In one embodiment, program data can be made accessible to the user via standard SQL queries for analysis and reporting purposes.

Primary elements of the invention can be server-based and can reside on hardware supporting an operating system such as Microsoft Windows NT/2000™ or UNIX. Clients can include a PC that supports Apple Macintosh™, Microsoft Windows 95/98/NT/ME/2000™, a UNIX Motif workstation platform, or other computer capable of TCP/IP or other network-based interaction. In a preferred embodiment, no software other than a web browser is required on the client platform.

Alternatively, the aforesaid functional components may be embodied by a plurality of separate computer processes (e.g. generated via dBase™, Xbase™, MS Access™ or other “flat file” type database management systems or products) running on IBM-type, Intel Pentium™ or RISC microprocessor-based personal computers networked together via conventional networking hardware and software and including such other additional conventional hardware and software as is necessary to permit these functional components to achieve the stated functionalities. In this alternative configuration, since such personal computers typically are unable to run full-scale relational database engines of the types presented above, a non-relational flat file “table” (not shown) may be included in at least one of the networked personal computers to represent at least portions of data stored by a system according to the present invention. Preferably, these personal computers run the Unix, Microsoft Windows NT/2000™ or Windows 95/98/ME™ operating system. The aforesaid functional components of a system according to the present invention may also comprise a combination of the above two configurations (e.g. by computer program processes running on a combination of personal computers, RISC systems, mainframes, symmetric or parallel computer systems, and/or other appropriate hardware and software, networked together via appropriate wide- and local-area network hardware and software).

A system according to the present invention may also be part of a larger computerized financial transaction system comprising multi-database or multi-computer systems or “warehouses” wherein other data types, processing systems (e.g. transaction, financial, administrative, statistical, data extracting and auditing, data transmission/reception, and/or accounting support and service systems), and/or storage methodologies may be used in conjunction with those of the present invention to achieve an overall information management, processing, storage, search, statistical and retrieval solution for a particular lock box service provider, e-payment warehouser, biller organization, financial institution, payment system, commercial bank, and/or for a cooperative or network of such systems.

As those in the art will recognize, another possible embodiment of the invention includes two-way data encryption and digital certification for data being input and output, to provide security to data during transfer. A further embodiment may comprise security means including one or more of the following: password or PIN number protection, use of a semiconductor, magnetic or other physical key device, biometric methods (including fingerprint, nailbed, palm, iris, or retina scanning, handwriting analysis, handprint recognition, voice recognition, or facial imaging), or other log-on security measures known in the art.

In a preferred embodiment, source code is written in an object-oriented programming language using relational databases. Such a preferred embodiment includes the use of programming languages such as C++. Other programming languages which can be used in constructing a system according to the present invention include Java, HTML, Perl, UNIX shell scripting, assembly language, Fortran, Pascal, Visual Basic, and QuickBasic. Those skilled in the art will recognize that the present invention may be implemented in hardware, software, or a combination of hardware and software.

The translation or mapping of EDI-type financial data, particularly of the X12, UN/EDIFACT, and NACHA formats, as discussed herein, is provided herein only as an example of transaction data capable of interacting with the invention and should not be construed so as to limit the use of the invention solely in such a setting. While the discussion herein presumes the use of the invention with respect to EDI, transactional, or financial data, it is anticipated that the invention may have utility in other contexts, as well.

In a preferred embodiment of the present invention, a financial transaction system is provided which is accessible to the end user client of one or more financial institutions via a web browser or workstation, and which is readily capable of integration with a plurality of back-office systems in the financial institution. Alternate embodiments of the present invention may include features such as failsafe backup and archival capabilities, reporting and instruction capabilities, data import and export capabilities, and advanced workflow management and security features. The financial institution client may utilize the present invention to execute virtually any financial transaction at the financial institution, including balance and transaction reporting, lockbox reporting, controlled disbursements, positive pay, check imaging, stop payments, and electronic funds transfer instruction. A system according to the present invention thus provides the financial institution client complete access to cash management, trade finance and securities processing capabilities through a single browser-based application.

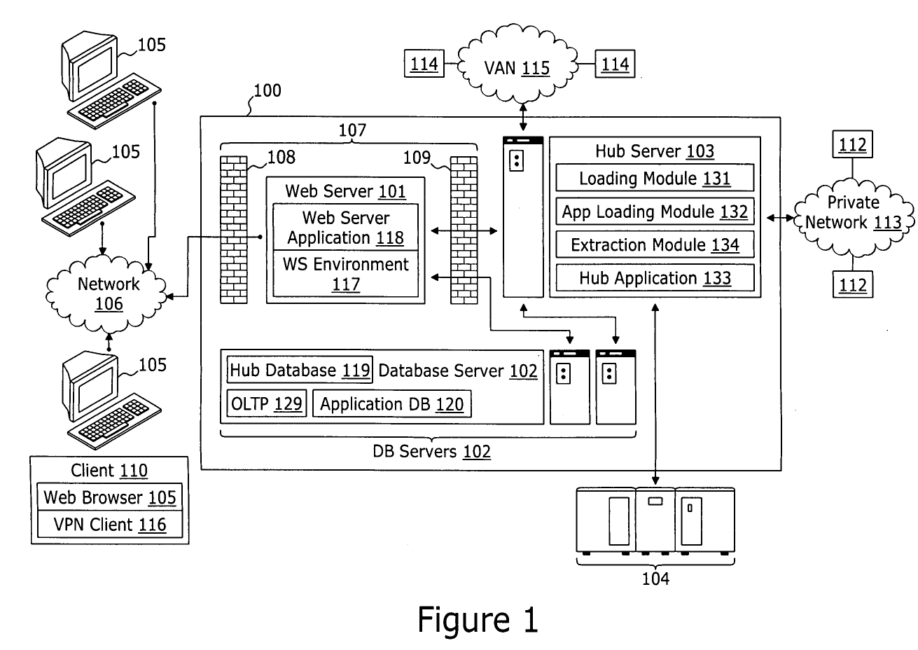

With reference now to FIG. 1, one embodiment of a financial transaction system 100 consistent with the present invention includes a web server 101, a database server 102, a hub server 103, an inner firewall 109 and an outer firewall 108.

The outer firewall 108 couples the web server 101 to a public network 106 such as the Internet and blocks unauthorized access to the web server 101 and other components of the financial transaction system 100.

A secure network zone 107 is formed between an outer firewall 108 and the inner firewall 109. This zone 107 is often referred to idiomatically as a DMZ (i.e. “de-militarized zone”) and the web server 101 is located therein. It is noted that additional firewalls may be placed between any one of a number of components of the present invention for security purposes.

The financial transaction system 100 interfaces with a plurality of client systems 110, a financial institutions back office transaction processing systems (back end systems) 104, and other financial institution systems 114.

Each client system 110 may be embodied in a PC or workstation 105 with sufficient hardware structure and operating system software for: i) operating a virtual private network (VPN) client 116 and a secure HTTPS client 105 such as a web browser; and ii) communicating over the Internet 106 to establish a secure session (either HTTPS, other transport layer secure systems, or through the VPN 116) with, and operate as a client to, the web server 101 of the financial transaction system 100. More specifically, under the direction of an authorized user, the client 110 can establish a secure connection to a specified URL of the web server 101 and, under control of the web server 101, both: i) communicate financial transaction data to the financial transaction system 100; and ii) receive financial transaction data from the financial transaction system 100.

The back office systems 104 may be traditional computer systems operated by a bank or other financial institution for managing financial transactions of its customers in a known manner. Traditional back office systems 104 are batch systems which receive financial transactions embodied in a batch input file and export financial transactions as part of a batch output file and, in the implementation of the present invention, are configured to exchange batch files with the hub server 103 of the financial transaction system 100.

Each batch file includes a plurality of transactions, each of which complies with a predefined transaction format. The predefined transaction formats may be those promulgated by various standards bodies. For example, transaction such as statements of assets, corporate notifications, securities reporting and corporate actions, and cash statements and advices may be output by the back office system 104 to the hub server 103 in the form of predefined SWIFT or BAI transactions. Similarly, securities settlement instructions and global payments may also be input to the back office systems 104 in the form of predefined SWIFT, FedWire, ACH, book transfers, or other predefined transactions.

Each of the other financial institutions 114 may be coupled to the financial transaction system 100 over a proprietary network 115 for exchanging financial transaction messages of a proprietary format with the financial transaction system 100. Examples include SWIFT, ACH, DDA, EDI, and FEDI.

In general: i) the web server 101 manages the secure exchange of financial transaction data with each client over the Internet 106; and ii) the hub server 103 manages the input and output of batch transaction files to the back end systems 104 and the exchange of formatted transactions with the other financial instructions 114.

The web server 101 includes a web server environment 117 and a web server application 118. The web server environment 117 may include known systems such as operating system and lower level networking and web server systems for: i) effecting secure connections between the web server 101 and each of the plurality of clients 110; and ii) managing the secure transport of documents and files there between.

The web server application 118 manages authentication of a user of a client system 110 and, after authentication, manages the interface of financial transaction between the client 110 and the hub server 103. In general, the exchange of financial transaction data with the client 110 occurs through: i) menu driven sequences of web documents and data downloads provided to the client 110 (populated with financial transaction data content provided by the hub server 103); and ii) HTTP posts and file uploads embodying financial transaction data received from the client 110.

The web server application 118 exchanges financial transaction data with the hub server 103 by: i) retrieving financial transaction data queued for delivery to a user group (to which the authorized user of the client 110 is a member) in a hub database 119 of the database server 102; and ii) loading financial transaction data received from the client 110 to the hub database 119 for subsequent retrieval by the hub server 103. A more detailed description of the structure and operation of the web server application 118 is included herein.

In general, the hub server 103: i) retrieves financial transaction data queued in the hub database 119 for loading by the hub server 103; ii) translates the financial transaction data for loading into the a hub application database 120; and ii) loads the translated data into the hub database 120 for processing by a hub application 123.

The hub server 103 operates various hub applications 120 for formatting the data for batch file input to the back end systems 104, queuing for extraction and delivery to a user group, and/or queuing for delivery to another financial institution 114.

The hub application 123 may further: i) generate financial transaction data for delivery to a user group (based on financial transaction data provided by other clients 110, the back end systems 114, or other financial institutions 114); and ii) queue such data in the hub database 119 for translation and delivery by the web server 101 to a member of the user group.

Database Server 102

In general, the database server 102 stores information needed for operation of the hub server 103 and the web server 101. The database server 102 includes an OLTP (on-line transaction processing) system 129, preferably embodied in an server, such as Microsoft SQL Server 7™, Oracle 8™, Sybase System 11™, DB2™, Informix™, or another ODBC-compliant database.

The database server is preferably configurable for sharing data with other applications by making database transactions available to both the web server 101 and the hub server 103 and managing the writing to data to (and reading of data from) the tables of the hub database 119, the application database 120, and other databases in accordance with predefined transactions called by the web server 101 and the hub server 103.

The database 102 may further comprise a distribution and replication protocol (DRP) device. A backup database server may also be provided, wherein some or all of the data on the database server is mirrored to the backup database server. In this configuration, in the event an application performing a transaction on the database server 102 experiences failure, the application can start at the backup server location and proceed from the point of failure, thereby preserving transaction integrity.

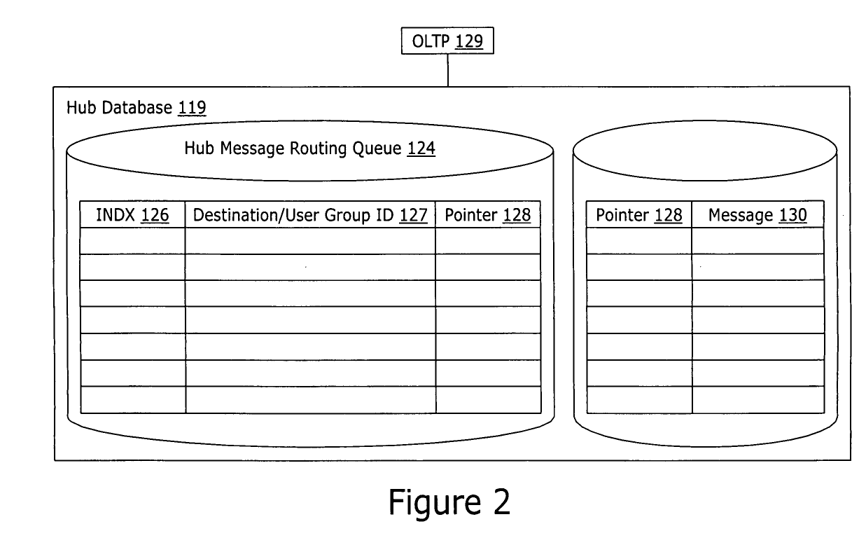

Referring to FIG. 2, the hub database 119 essentially comprises routing queues embodied in a hub message routing queue 124 and a hub message queue 125.

The hub message queue 125 stores a plurality of messages 130, each in association with a pointer 128. The hub message routing queue 124 associates each pointer 128 with identification of a destination/user group ID associated with the intended recipient of the message 130. It should be appreciated that this structure enables a message 130 (stored in a single record of the hub message queue) to be queued for delivery to multiple destination/user group IDs 127—each specified in a distinct record of the hub message routing queue 124.

Hub Server

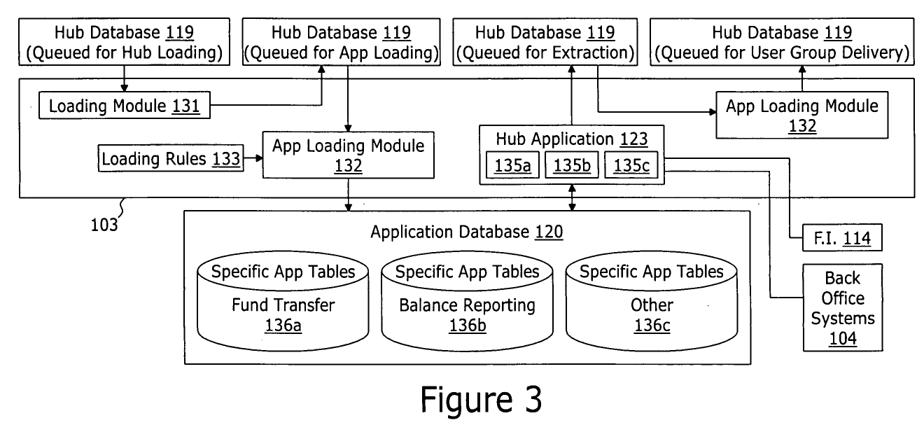

Turning now to FIG. 3, the hub server 103 and its various modules in a preferred embodiment of the invention are shown. Hub server 103 comprises a loading module 131, an application loading module 132, hub applications 123, and an extraction module 134.

In general, financial transaction data received from a client 110 and queued in the hub database 119 for hub loading (e.g. the destination ID 127 (FIG. 2) includes an indication of the loading module 131), retrieved, translated, and queued for application loading in the hub database 119 by the loading module 131. The translated financial transaction data is then retrieved and loaded into the application database 120 by the application loading module 132. Once in the application database 120, the data is manipulated and/or transferred to the back office systems 104 and/or other financial institutions 114 by the hub application 123.

Financial transaction data that is to be delivered to a user group is transferred to the hub database 119 by the hub applications 123 and queued for extraction. The data is then translated to a format compatible with the systems of the user group and queued for user group delivery in the hub database 119 by the extraction module.

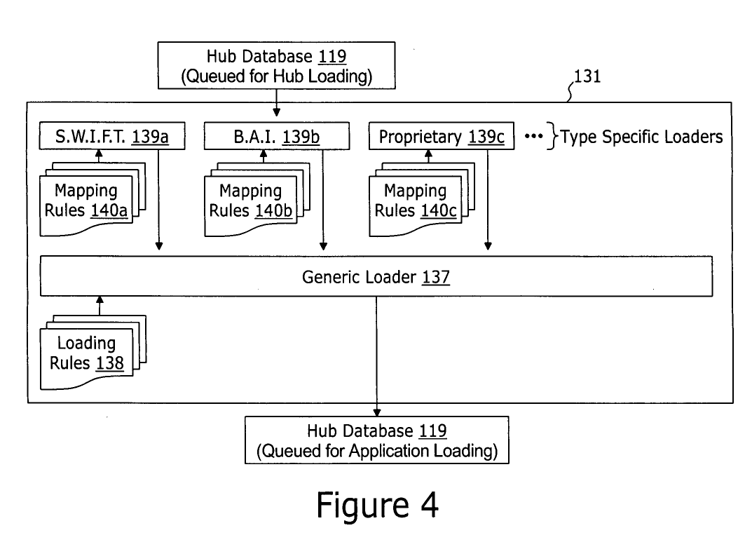

Turning briefly to FIG. 4 the exemplary structure of the loading module 131 is shown in more detail. The loading module 131 comprises a plurality of rule driven type-specific loaders 139a-139c (each driven by corresponding mapping rules 140a-140c) and a generic loader 137 driven by loading rules 138.

The mapping rules 140a-140c (which may be written in a scripting language) define how a data (message or file) will be loaded through the type-specific loaders 139a-139c to the generic loader 137 and the loading rules 138 (which may be written in a scripting language) define how data will be loaded through the generic loader 137 and queued for application loading in the hub database 119.

Referring to FIG. 2 in conjunction with FIG. 4, in operation, each loader 139a-139c retrieves messages stored in the hub message queue 125 (with a pointer 128 that associates with the applicable type specific loader 139a-139c) and performs translation to a “flat format”. The loader 137 using loading rules 138 directs the flat format data to the hub message queue 125 with a pointer 128 that associates with the queue for the application loading module 132.

Each type-specific loader 139a-139c is created to accommodate a specific transaction file format (e.g. SWIFT, BAI, fixed format), and is linked to the generic loader 137, which is maintained as part of the core system. For example, in an exemplary embodiment, there are four types of loaders 139a-139c and corresponding map classes 140a-140c. The first is a SWIFT format mapper 139a (for SWIFT or SWIFT-like formats & other tagged message formats), wherein specific rules can be specified regarding how a key tag or code word should be mapped. The second is a BAI format mapper 139b (for BAI formatted feeds), which accounts for different interpretations of BAI that take place from bank to bank. The third is a fixed length mapper 1304, used for proprietary feeds & interfaces, in which all info regarding the file format must be provided in a script file.

Returning to FIG. 3, the application loading module 132 (using loading rules 133) operates an application loading process which takes the flat transaction queued for application loading off the hub database 119 and loads it into the application database 120. The application loading module 132 may further perform an archive process for removing historical data from primary application data tables of the database 120 to archive tables with longer data retention and an indexing scheme to support archival lookups.

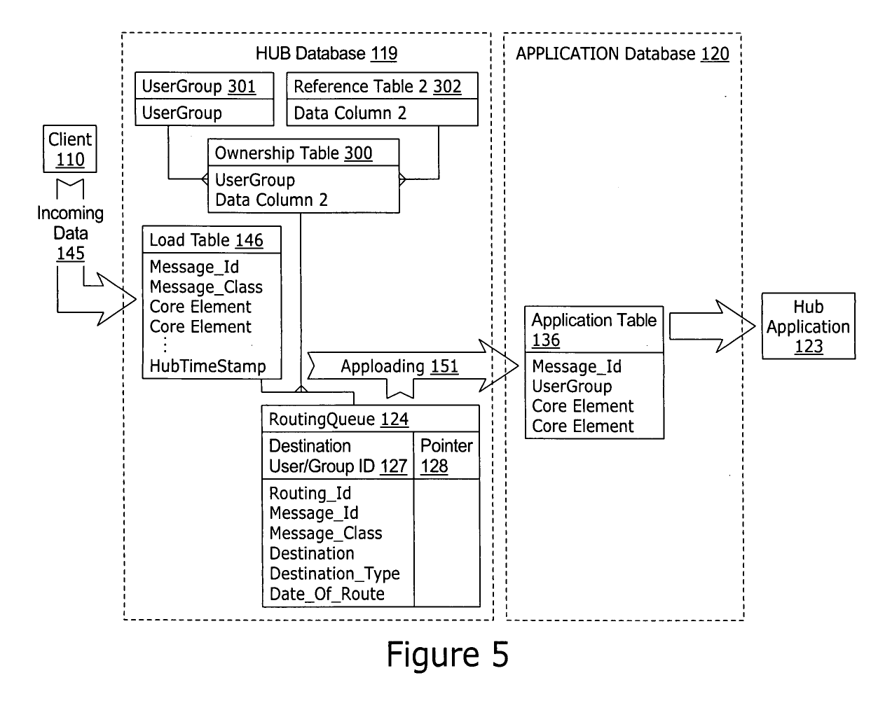

The block diagram of FIG. 5 is a more detailed representation of the loading of incoming financial transaction data 145 provided by a client 110 to the application database 120. As discussed, the application loading process (or routine) is separated into a type specific sub-process (or subroutine) and an application loading process (or subroutine).

The purpose of loading and application loading is to: i) retrieve the financial transaction data 145 provided by the client 110 and queued for loading in the hub database 119; ii) apply the necessary formatting thereto; and iii) place the data into an appropriate table in the application database 120, whereby the data become available to the hub applications 123.

For each transaction there are a plurality of data elements (and sub elements) within the transaction. For example, a date may be a data element, and each of the month, day, and year may be sub elements of the data element. The sub elements are the smallest units of information within the transactions and are referred to as core elements. The type specific loader 139a-139c parses or translates each transaction (of a type that correspond to the type specific loader 139a-139c) to its core elements, and the generic loader 137 stores each core element in one field in a load table 146 of the hub database 119. The parsed transaction may be referred to as a “flat transaction”. While these units of information (e.g. core elements) will be referred to herein as “core elements”, for SWIFT an alternative name “SWIFT statement” may also be used.

The load table 146 may be a storage for the interface between the loading and the application loading processes and: i) may be identified in the message field 130 of the hub message queue 125; or ii) may itself be stored as an object within the message field 130 of the hub message queue 125.

In the exemplary embodiment, the message ID field of the load table 146 stores a message ID value that value that is an automatically incrementing integer number that enumerates and uniquely identifies loaded messages.

The message class record stores a value representative of the class of message stored in the table 146.

The hub time stamp record stores a value representing the exact date and time the message was loaded—for audit purposes. The remainder of the records store data elements specific to the transaction, some of which may be used in ownership or validation rules.

The loader 137 further writes destination information to the destination user group ID field 127 of the hub message routing queue 124. Exemplary information written to sub fields thereof may include: a routing ID, a message ID, Message Class, Destination, Destination Type, Date of Route, or other destination information useful for identifying that the flat transaction is to be loaded into a specific one of the application tables 136a-136c of the application database 120.

Returning to FIG. 5 in conjunction with FIG. 3, the application loader 120 performs the application loading process 151 which: i) locates new records in the hub message routing queue 124 with destination information associated with application loading; and ii) reads the core elements of the “flat transaction” from the load table 146 and loads the applicable data elements to the appropriate records and fields of the specific application table 136 of the application database 120 which correspond to the destination information in the routing queue 124. The application loader 132 may further write a time stamp value to the load table 146 indicating the time that the data elements were loaded into the appropriate application table 136.

In an exemplary embodiment, each load table 146 in the hub database 103 has a corresponding application table 136a-136c in the application database 120, which consists of the same columns and records as the load table 146, with the addition of UserGroup information and BankMnemonic information and the exclusion of the MessageClass designator.

It should be appreciated that during the parsing and loading processes some of the data elements (or entire transactions) may be dropped, based on per-transaction ownership rules. Further, in the case of the transactions being part of a batch file, the whole batch may be discarded based on the per-file validation rules. Discarded data elements, transactions, and batches may be deleted from the load table 146 and the hub message queue 125.

It should also be appreciated that an archive process may be included. In the archive process, historical data is removed from primary application data tables 136 into archive tables (not shown) with longer data retention, and an indexing scheme is provided to support archival lookups in the archive tables. It is noted that if the archive process is made part of the application loading process and data is therefore archived at each loading instance, the archive generated will always be representative of the actual data loaded.

Returning to FIG. 3, each of the specific application tables 136a-136c, stores data within a data model that is configured for a specific application or product (e.g. letter of credit, securities instruction, etc.) operated by the hub application 123. Exemplary application tables 136a-136c comprise one or more funds transfer tables 136a, one or more balance reporting tables 136b, and one or more tables supporting other financial transaction applications or products of the hub application 123.

The hub application 123 comprises a plurality of hub data models 135a-135c which may be in SQL database format. Each hub data module 135a-135c is created to perform a specific application or product processing of data stored within the corresponding application tables 136a-136c of the application database 120. In addition to data processing, the hub data modules 135a manage: i) the exchange of financial transaction data between the application database 120 and the back office systems 104 (FIG. 1) and other financial institutions 114 (FIG. 1); and ii) delivery of financial transaction data to user groups through clients 110 (FIG. 1).

Financial transaction data is delivered to clients 110 through an extraction process that includes formatting an outbound transaction (or other data) before making it available to the user group using clients 110.

As discussed, financial transaction data that is to be delivered to a user group is written to the hub database 119 (in a core element format) by the hub application 123 and queued for extraction. The extraction module 134 reformats the financial transaction data to a data element format applicable to the destination user group and writes the reformatted financial transaction data to the hub database 119 queued for user group delivery.

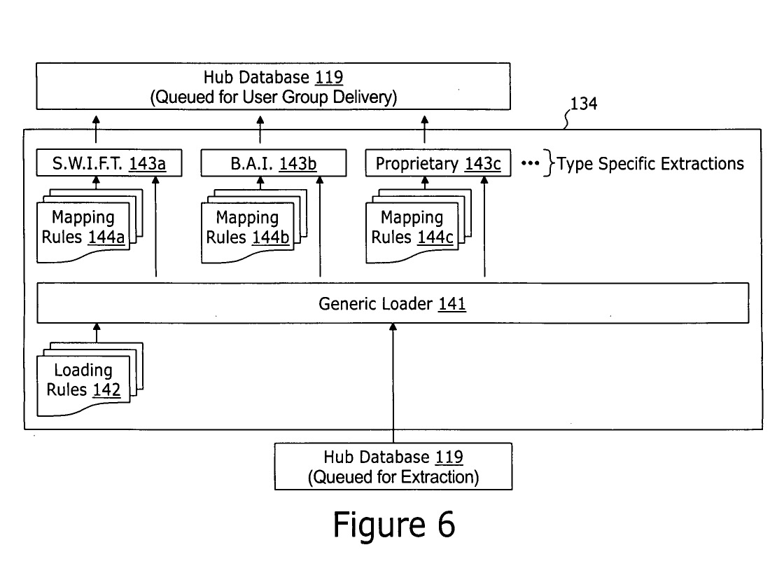

Turning briefly to FIG. 6, the extraction module 134 is shown in more detail The extraction module 134 comprises a plurality of type specific extractors (or reformatters) 143a-143c, which are multi-threaded processes allowing for the simultaneous extraction and/or reformatting of outgoing financial transactions.

Each of the type specific extractors 143a-143c operates in accordance with type specific mapping rules 144a-144c. A generic extractor 141 is also used, having a set of common extraction rules 142, regardless of data type.

Three exemplary type specific extractors 143a-143c include: i) a SWIFT format mapper 143a (for SWIFT or SWIFT-like formats & other tagged message formats), wherein specific rules can be specified regarding how a key tag or code word should be mapped; ii) a BAI format mapper 143b (for BAI formatted feeds), which accounts for different interpretations of BAI that take place from bank to bank; and iii) a fixed length mapper 1374, used for proprietary feeds & interfaces, in which all info regarding the file format must be provided in a script file.

It is noted that loading and extraction rules are interchangeable, since both deal with the process of reformatting messages by string manipulation, table lookups, and the creation of logical output records expected by the receiving function. Thus, although the extractors/reformatters are described herein as separate modules or program components from the loaders/mappers described herein, it is understood by those skilled in the art that a single set of mappers may be used to perform both the loading and extraction functions. It is also noted that, while four extractors are depicted and described herein, any number of extractors of varying types may be used.

It should also be noted that while the hub server 103 is often referred to herein in the singular, a plurality of hub servers may be employed to process large quantities of batch data in narrow windows of time. It is appreciated by those skilled in the art that some or all the software/application modules and/or databases described herein as being located on one or more hub servers may alternatively be located on one or more web or other servers.

Web Server Application

As discussed, the web server application 118 drives the functionality of the web server 101 in the authentication of users and the exchange of financial transaction data between the hub server 103 and the clients 110. More specifically, the web server application 118 provides web documents to the client 110 (e.g. HTML documents, XML documents, and/or other web based documents including data, formatting, and/or executable script for operation on the client 110) and receives data posts from the client 110 in accordance with menu driven work flow models. The web documents include data content obtained form the database servers and formatting applicable to the work flow model and the client 110.

In one embodiment of the present invention, the menu driven work flow models or processes of web server application 118 provide for each user to have one (or more) of three access classes: administrative access, information provider access, and information recipient access. Each access class is associated with certain processes which members of the class are permitted to perform.

The administrative access level provides for its members to access processes for provider and recipient access control (e.g. user groups, user IDs, passwords, host setup); data ownership setup (e.g. account setup, inter-group access control); routing rules (which transactions should be routed where, based on what factors, and into what format); remote approval rules (which transactions require further authorization from another site); transaction cutoff times (taking into consideration time zones, local holidays, and transaction characteristics); job scheduling (when batch operations should take place, how frequently, and what should happen based on different results); system alarms (configure which events should raise concern and what should be done if those events occur); transaction monitoring (tracking instruction transactions through their stages of execution); transaction inquiry (access to all data and what state it is in); audit trail (an independent log of all activity at the hub server 103, which can be queried); and reference data maintenance (central tables that can be shared by some or all of the hub user community).

The information provider access level provides for its members to access to processes for providing specific types of financial transaction data (associated with the user group of the user) to the financial transaction system 100.

The information recipient access level provides for its members to access to processes for obtaining specific types of financial transaction data (associated with the user group of the user) from the financial transaction system 100.

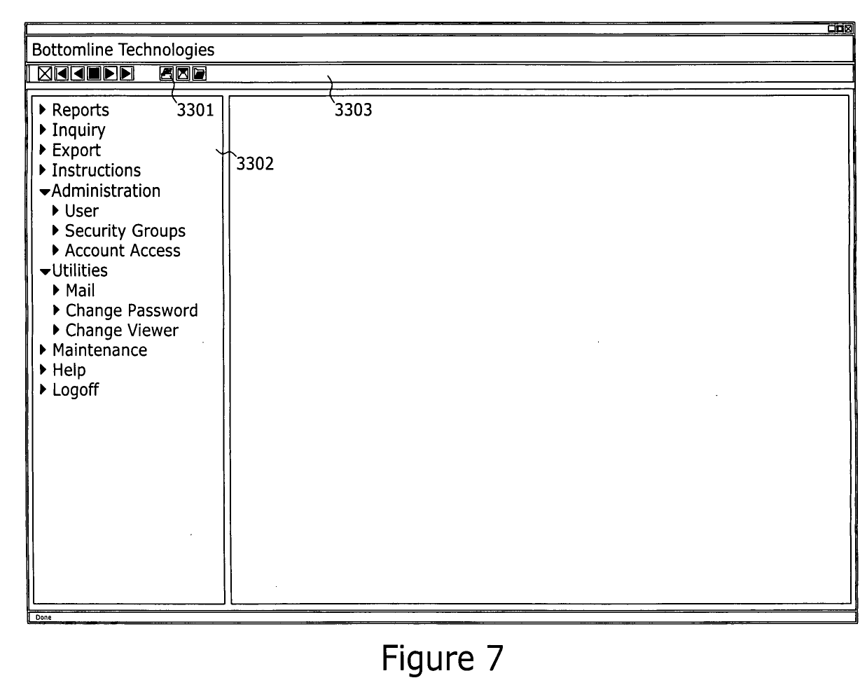

After a user is authenticated, an initial menu, as represented in FIG. 7, may be provided to the user. The menu may include only those functions available to members of the access level which corresponds to the user's access level.

Members of a data recipient access level may typically obtain reports for viewing, printing, saving and/or downloading. In a preferred embodiment, three categories of reports may be generated: standard reports, ad hoc reports, and profile reports. In the standard report, the sort and selection criteria are automatically set for the type of report selected by the client. For example, if the user chooses a “wire activity” report, only current day transactions might be selected for output as a report, depending on predetermined sort and filter criteria. Ad hoc reports allow customization of sort and selection criteria “on the fly”, thereby allowing the client to query large quantities of information and specify filter and sort criteria tailored to the search requirements (e.g. amount, transaction number, customer name, etc.). For example, a client may elect to include in the report all checks from the previous day sorted in descending sequence. In the profile report, the client can save ad hoc report settings for later sorting and searching based on the same criteria, thereby eliminating the need to specify customized filtering and sorting criteria each time the same kind of report is needed.

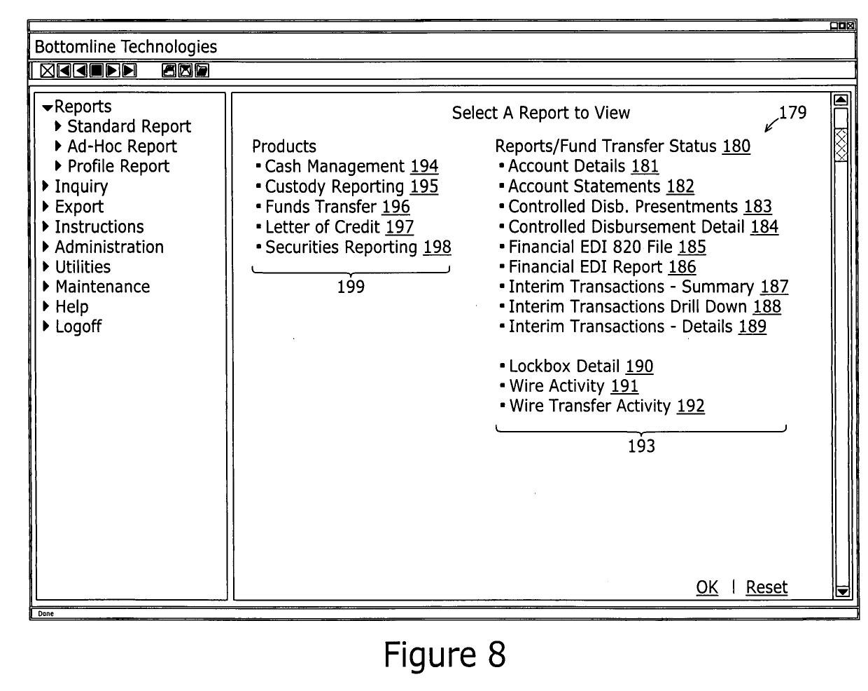

As can be seen in FIG. 8, in report view menu 179, reports 193 and products 199 available to the client are set up by the administration system for each client, and only those products 193 and reports 199 designated for that client appear as menu options.

In this example, products 199 include cash management 194, custody reporting 195, funds transfer 196, letter of credit 197, and securities reporting 198.

Reports 193 include fund transfer status 180, account details 181, account statements 182, controlled disbursement presentments 183, controlled disbursement detail 184, financial EDI 820 file 185, financial EDI report 186, interim transactions summary 187, interim transactions drill-down 188, interim transactions details 189, lockbox detail 190, wire activity 192, and wire transfer activity 193.

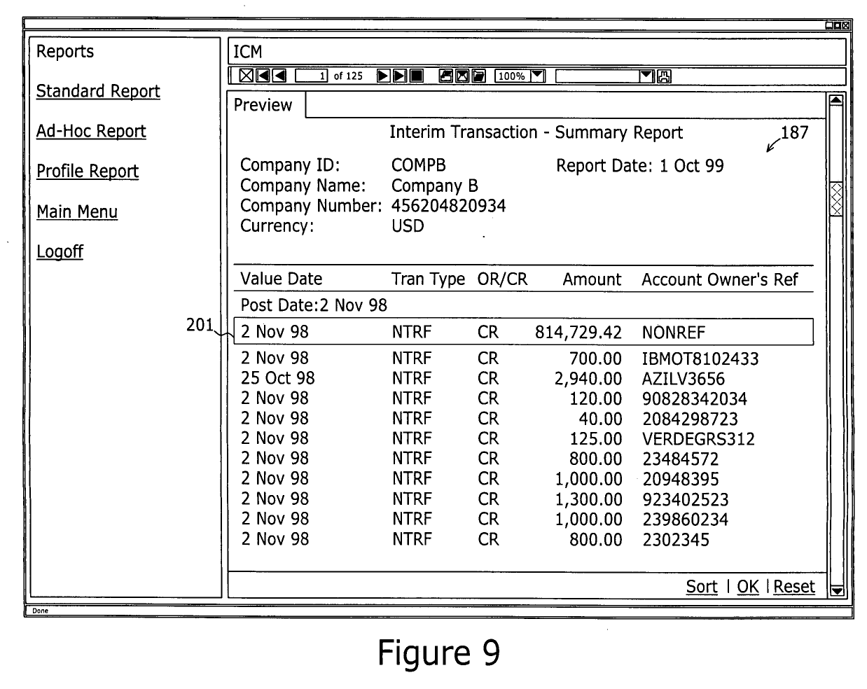

FIG. 9 illustrates an exemplary interim transaction summary report 187, including report date, company ID, company name, account number, currency, and for each transaction listed, the value or post date, transaction type, amount, and account owner's reference.

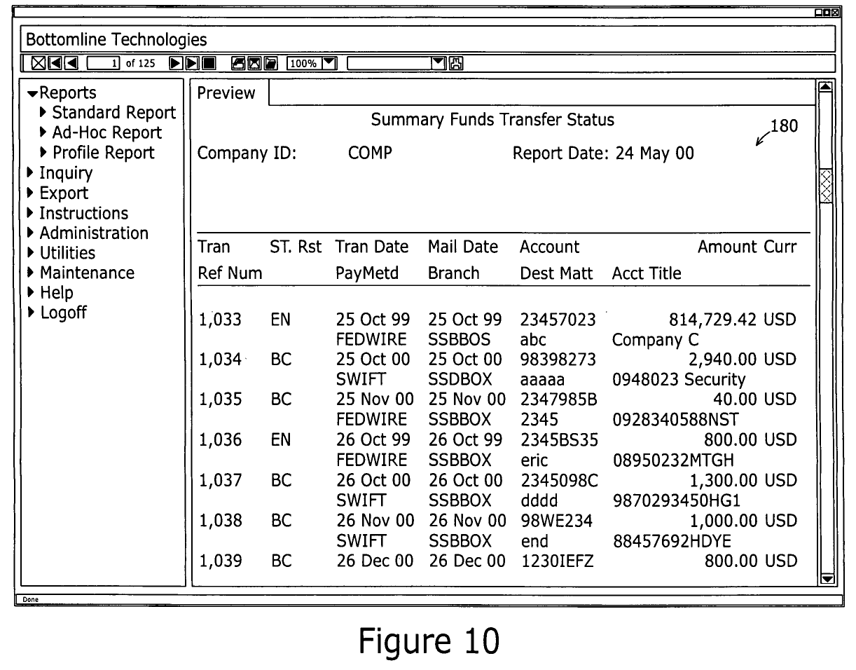

FIG. 10 illustrates an exemplary summary funds transfer status report, including report date, transaction/reference number, transaction type, transaction date, payment method, validation date, branch, account number, beneficiary name, account title, amount, and currency.

Referring again to FIG. 9, in a preferred embodiment, the client can “drill down” from a summary report to view the associated underlying transaction details or updated information, which action may preferably be performed by the client double-clicking a particular row or entry on the summary view screen (e.g. row 201).

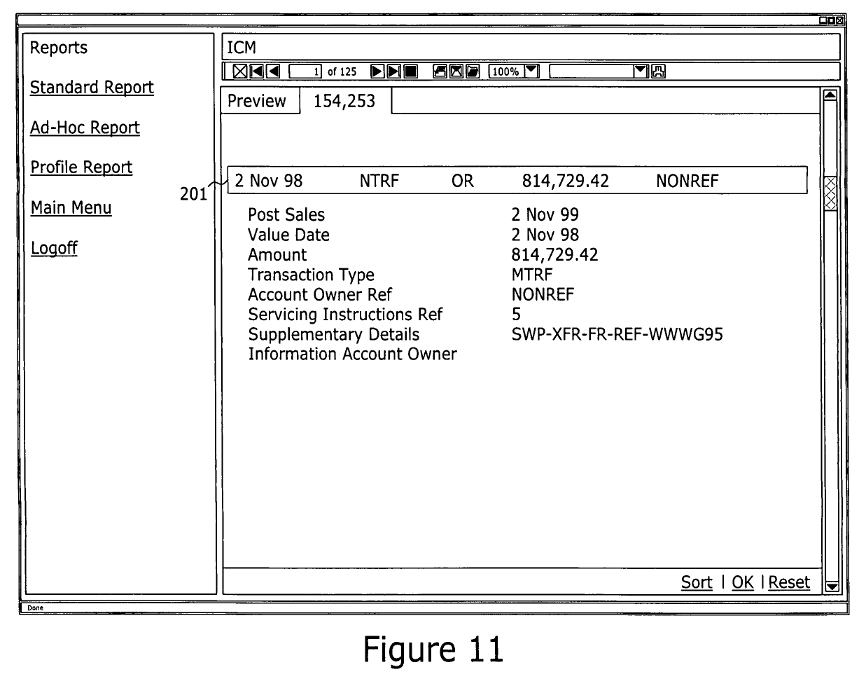

FIG. 11 illustrates an exemplary “drill down” or transaction detail view of row 201 of FIG. 9, including the original information from the summary view, post date, value date, amount, transaction type, account owner reference, servicing institution's reference, supplementary details, and information to account owner. A selection button is provided to navigate the client back to the summary report.

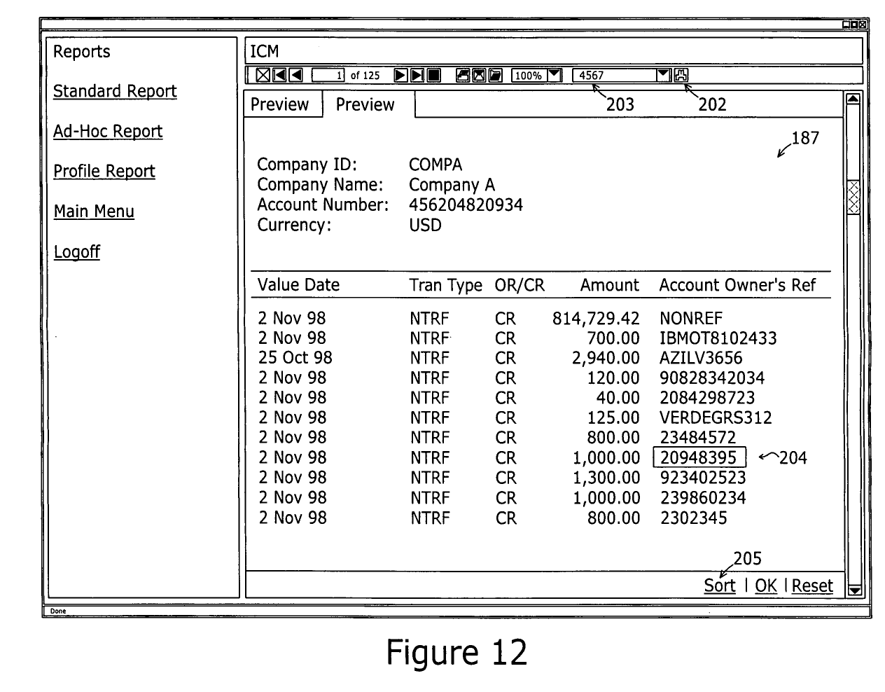

As FIG. 12 shows, the client can click on a search button 202 to search a report 187 for a text string 203 (in this case “4567”), wherein each occurrence of the string is annotated by highlighting, underlining, bolding, color change, bordering by a rectangle 204, or otherwise. A sort button 205 is provided to the user to perform ad hoc sorts and/or selections from a sort view, which presents each sortable element within the report, with the option to force a presorting of data for presentations.

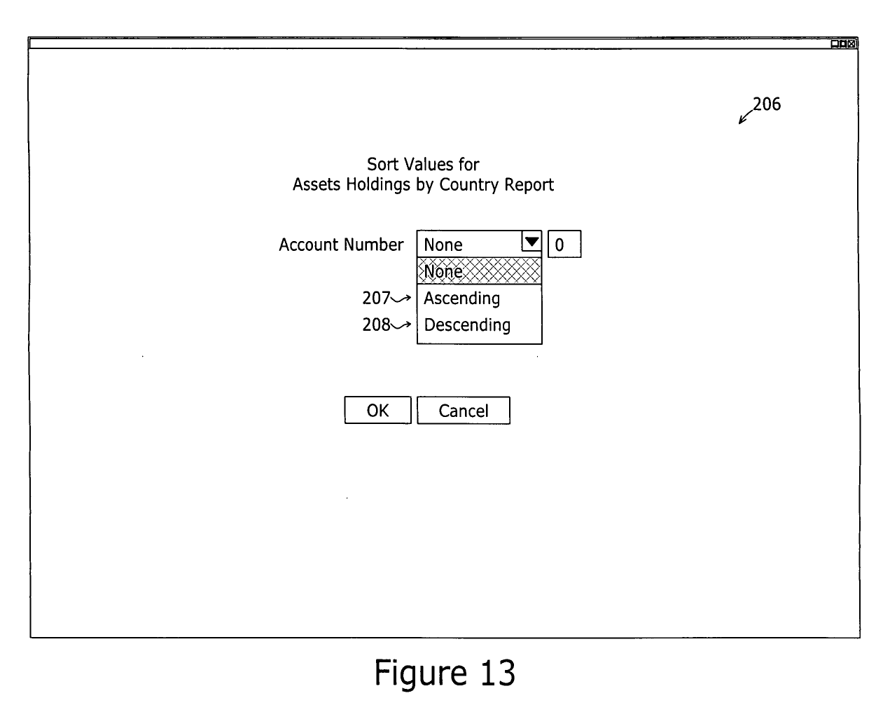

FIG. 13 shows an exemplary graphical user interface control 206, wherein a user can choose to view asset holdings by country based on either an ascending 207 or descending 208 account number.

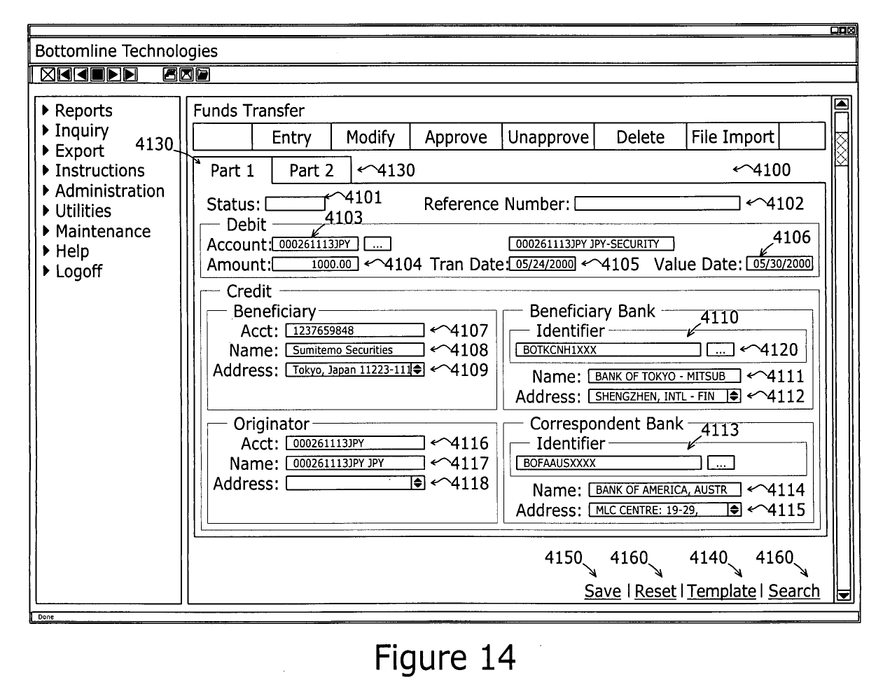

Members of a data provider access level may typically enter, modify, delete, approve, unapprove, and/or reject transactions or instructions using the web interface, either by manually entering information or by uploading files via the web interface. Preferably, a customizable payment transaction entry screen is provided, as shown in FIG. 14, wherein once a user has chosen a transaction type, the user is presented with an interface 4100 which provides for the application of bank back-office or straight through processing rules (including, e.g., holiday checks required to prevent transactions from failing within the financial institution clearing system).

In the represented embodiment, exemplary transaction interface 4100 includes a plurality of fields for entering transaction data, including status 4101, reference number 4102, originating account number 4107, originator name 4117 and address 4118, correspondent bank identifier (e.g. bank code or ABA number) 4113, bank name 4114, and bank address 4115. For credit transactions, fields provided for data entry include account number 4107, beneficiary name 4108 and address 4109, beneficiary bank identifier 4110, and bank name 4111 and address 4112. For debit transactions, fields provided for data entry include account 4103, amount 4104, transaction date 4105 and value date 4106. Also preferably included may be at least one button 4120 which can be used for “popping up” a “pick list” of valid entries from which the user may select, rather than requiring the user to enter the characters comprising the data of a field manually. Additionally, in a preferred embodiment, the end user is not required to enter data for all of the fields, as some of the fields will be automatically supplied by the application server. For example, one the user has selected the identifier 4113 of the beneficiary's bank, the name 4114 and address 4115 of the beneficiary's bank are automatically displayed in interface 4100. A plurality of tabs 4130 may optionally be provided to support complex transaction types requiring the entry of more data than can fit in one screen view at a time, such as letters of credit and securities transactions. In one embodiment of the invention, the user can choose to create a new transaction from scratch, from a prior transaction, or from a template accessed by button 4140, previously saved using button 4150. The user may clear all fields using reset button 4160, or my perform a search, accessed by search button 4160.

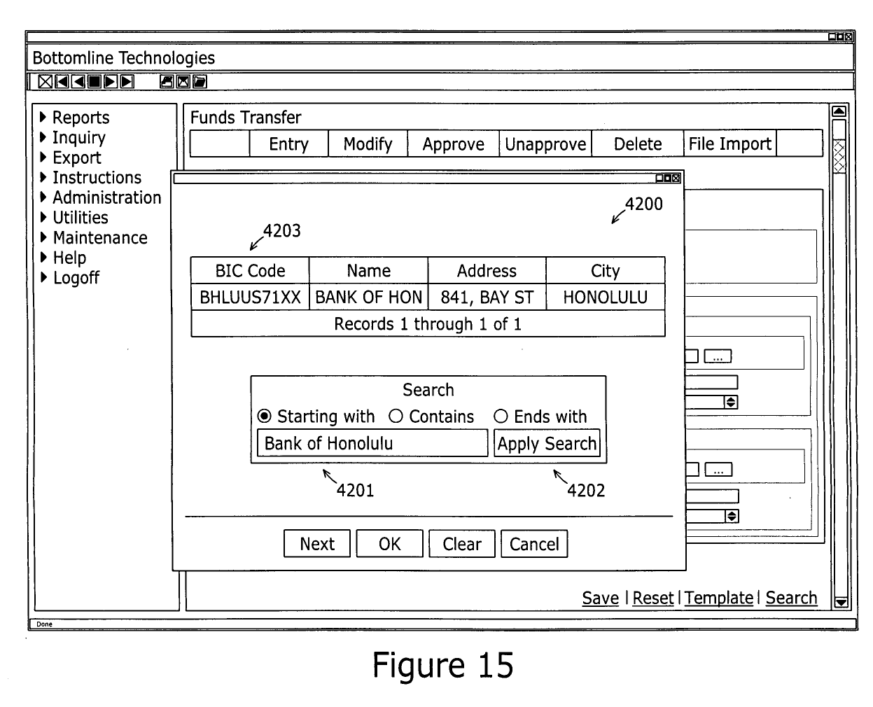

Search functionality is also preferably provided through a web interface, as shown in the exemplary search interface 4200 shown in FIG. 15. Interface 4200 allows the end user client to perform large-scale database lookups for fields and associated interrelationships of accounts, addresses, and other data pertinent to the lookup. In the example shown, a user has searched for “Bank of Honolulu” within the hub database, from among over 60,000 SWIFT BIC directory listings, by entering the string into search field 4201 and pressing the search button 4202. The results are returned in a results view area 4203. Similar searches may be performed on any of the associated fields in which data elements are known. The user may then select from among the results returned 4203 and insert the selection directly into the specific transaction being performed.

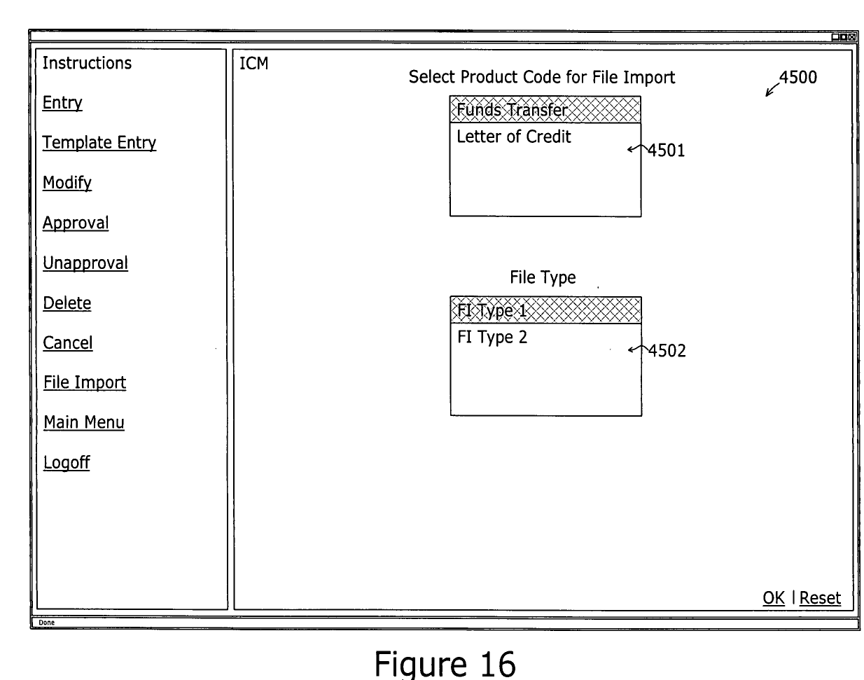

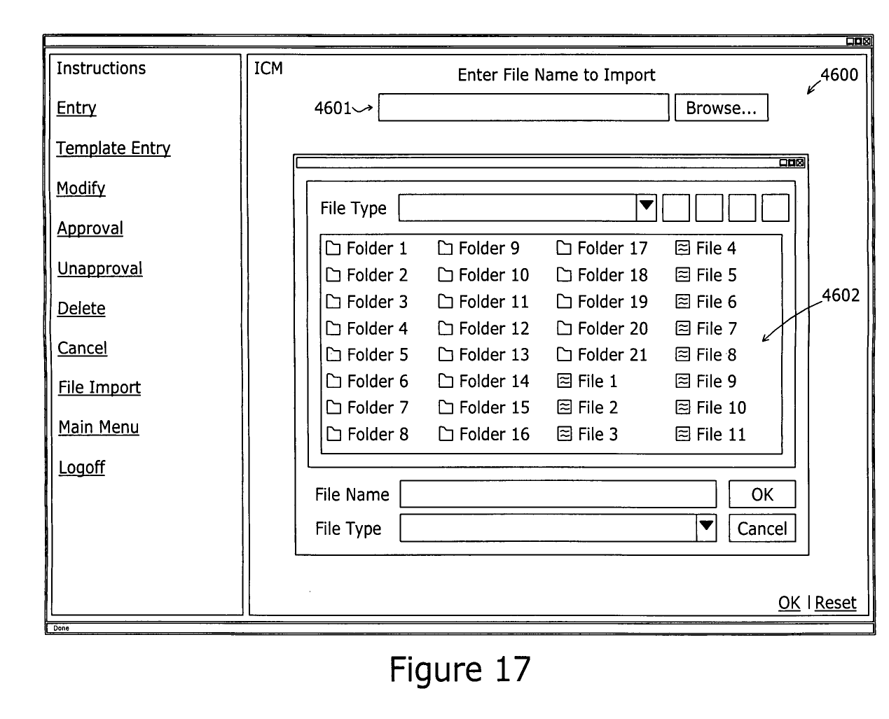

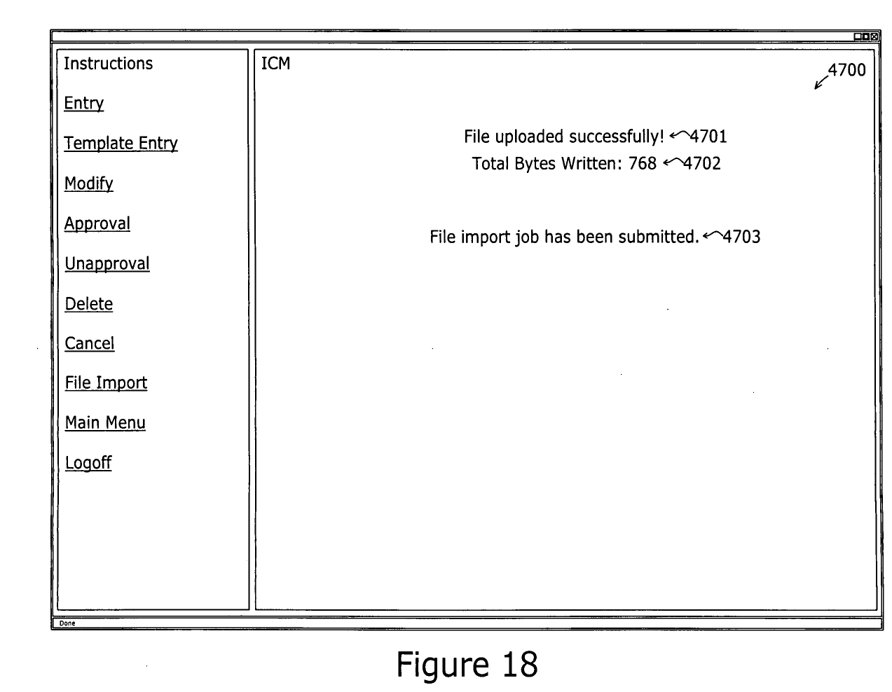

In addition to manual entry, data entry into the hub may also be performed by uploading or importing a file via the web browser interface. FIG. 16 illustrates an exemplary file import interface 4500 in one embodiment of the invention, wherein product code 4501 and file type 4502 may be selected. FIG. 17 shows file import filename entry interface 4600 in one embodiment of the invention, including filename entry 4601 and/or filename selection interface 4602. FIG. 18 shows file import confirmation view 4700 in one embodiment of the invention, including a success or fail message 4701 and import file size confirmation 4702, as well as confirmation 4703 that the file import job has been submitted to the hub. Import file formats may include delineated, tagged or fixed length.

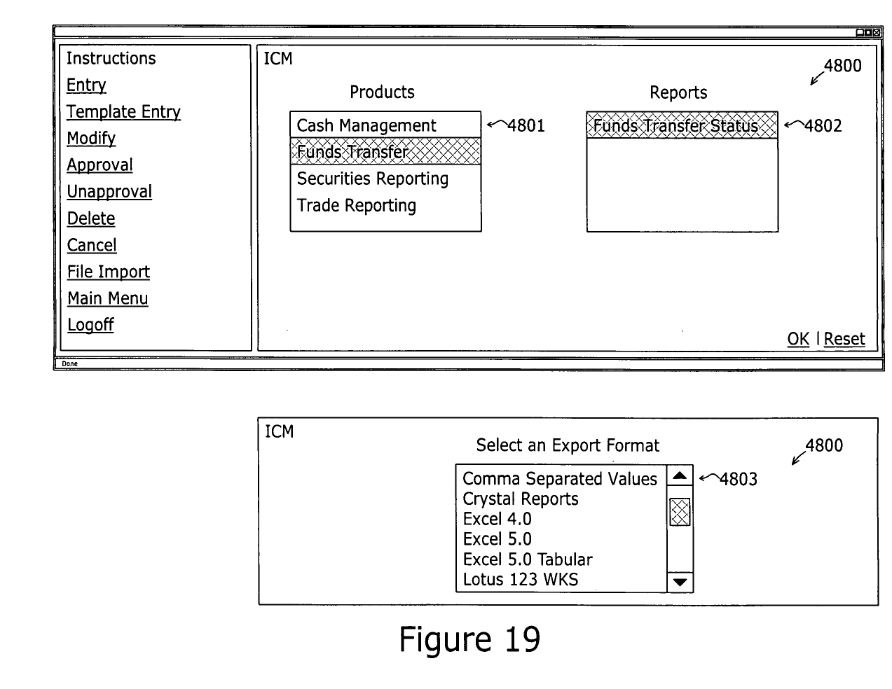

Likewise, data may be exported (by groups with information retrieval capabilities) by downloading of files via the web browser interface. As shown in the example of FIG. 19, using export interface 4800, the user may select a product 4801, a report or file layout 4802, and an export file format 4803. The export file is preferably compressed into a self-extracting format (such as a PKZIP-generated executable file) and made available for download by the user over a secure http (shttp) or SSL transport.

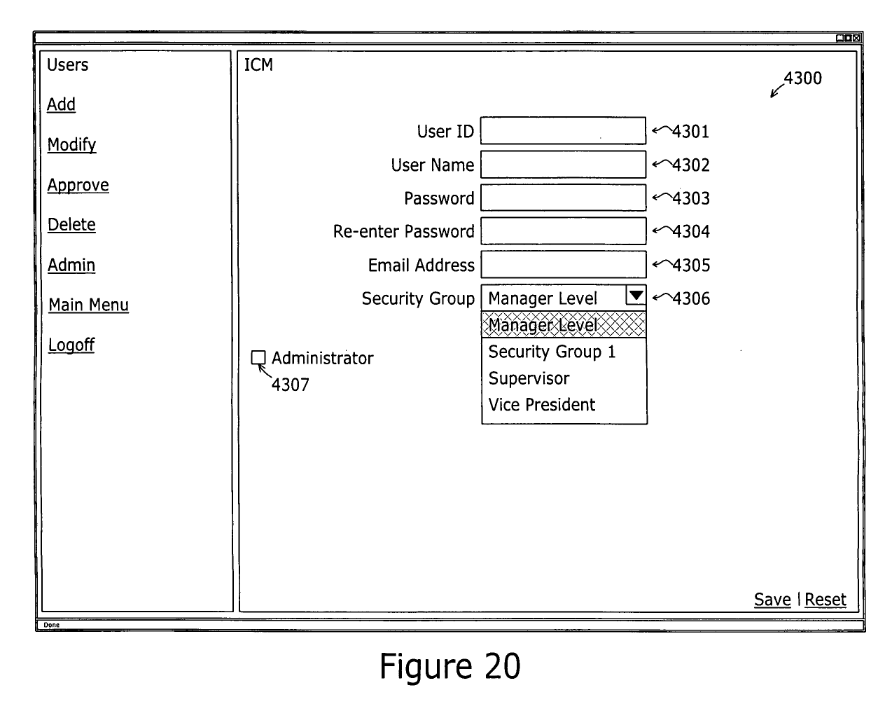

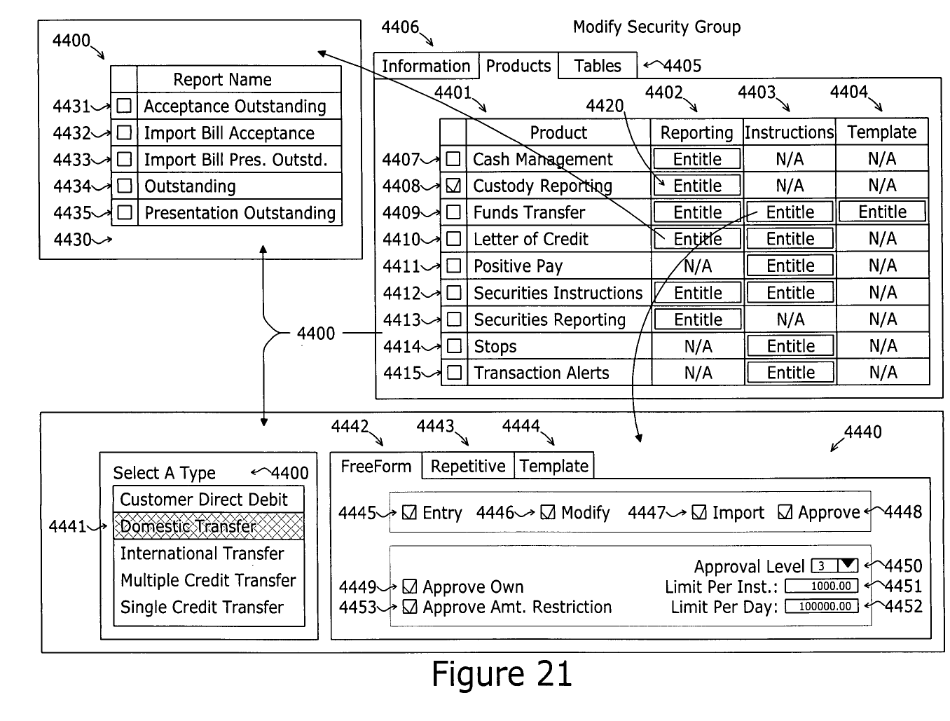

Members of an administrative access group may typically modify user IDs, passwords, and/or security groups may also make such modifications via a web interface, or create or delete user IDs, as shown in the exemplary interfaces of FIGS. 20 and 21. FIG. 20 illustrates a user ID maintenance interface 4300 allowing a user with administrative rights to modify fields for another user, including user ID 4301, user name 4302, password 4303, e-mail address 4305, security group 4306, and administrator status 4307. A password verification field 4304 may be provided to ensure correct entry of the password as intended. FIG. 21 illustrates a plurality of screens which are part of the security group maintenance interface 4400 in one embodiment of the invention. For several of a plurality of products 4401, security entitlements for reporting 4402, instructions 4403, and template 4404 access may be selected. Products for which entitlements may be specified include in this example cash management 4407, custody reporting 4408, funds transfer 4409, letter of credit 4410, positive pay 4411, securities instruction 4412, securities reporting 4413, stops 4414, and transaction alerts 4415. Entitlements for access to non-product features, including access to data tables and information functions, may be selected using data tables tab 4405 and information tab 4406. Once a product 4401 and one of reporting 4402, instructions 4403 or template 4404 is selected by an “Entitle” button 4420, the user may then specify entitlement criteria in a submenu, such as report name submenu 4430 or instruction type submenu 4440. The report name submenu 4430 includes the capability to grant a user permission to access one of a plurality of reports, including acceptance outstanding 4431, import bill acceptances 4432, import bill presentations outstanding 4433, outstanding 4434, and presentation outstanding 4435. Instruction type submenu 4440 includes instruction type selector 4441, tabs to select access options for freeform 4442, repetitive 4443, and template 4444 functions, and entitlement selections for entry 4445, modification 4446, import 4447, and approval 4448 functions. Also included are a field for selecting whether a user may approve his or her own transactions 4449, approval level 4450, and whether there is a restriction on approval amount 4453, with fields for the corresponding monetary limit per instruction 4451, and limit per day 4452.

In one embodiment of the present invention, four separate work groups (sub groups within the administrative access level) may be established to perform the function of system administration. These four work groups are central administration and operations (CAO), customer service units (CSU), client enterprise user groups (CEU), and client user groups (CU).

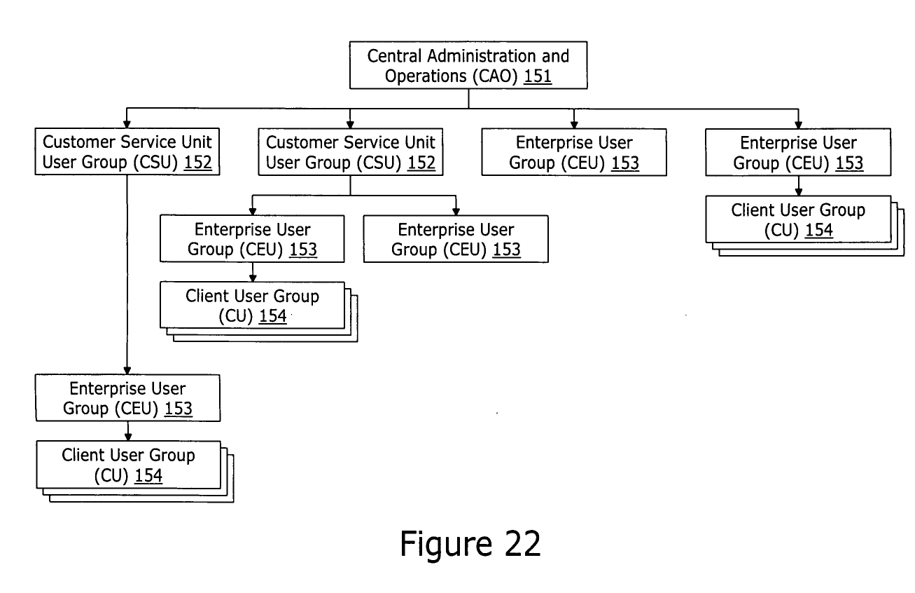

FIG. 22 shows the dependency relationships between the four workgroups in one embodiment of the present invention, including a CAO group, two CSU groups, five CEU groups, and nine CU groups. The lines shown in Figure H indicate dependencies, and not necessarily direct authority, i.e. CEUs are required for the creation of CUs, but a CEU user may not necessarily be able to create CUs.

The CAO 151 has the highest level of authority and is responsible for the overall operation of the financial transaction system 100. The CAO 151 can perform any of the functions that the lower level work groups can perform and can access many tables and functions inaccessible to any other users or work groups.

The CSUs 152 are responsible for client setup and support and can also perform the functions of lower client administration groups (CEU and CU). CSU administrators have access to any of the CEUs and CUs that have been assigned to a given CSU. For less sophisticated clients, the CSU administrators will perform the functions of the CEU and/or CU.

The CEU 153 can act as a master user group for a given enterprise. A CAO or CSU user must set up a CEU group before the CAO/CSU user can create new CU groups. These new CU groups can be granted access to a subset of any of the accounts or functions granted to the CEU group. Additionally, the CEU group has access to the remote approval rules so that the CEU administrator can configure workflows between user groups across the enterprise. The CU groups 154 have access to a set number of accounts that has been granted to them by a CAO, CSU, or CEU. The administrator of the CU group decides which products, reports, transaction types, and instruction templates an end user within the group is permitted to access. It is noted that the CAO and CSU groups are critically different from the CEU and CU groups in that only the CAO and CSU groups can create and maintain accounts. The CEU can only allocate accounts that have already been created and allocated by either a CSU or a CAO user. A CEU can exist independent of any ownership of CUs, but must exist to create CUs.

All clients who are end users of the present invention must “belong to” or be associated with a CSU. The CSUs are responsible for setting up and supporting their own client base. CSUs can be organized in a number of ways, including by geographic region and by application product group (e.g. custodial applications may fall under a different support organization from trade finance applications, but both may be implemented on the same server). In a preferred embodiment of the invention, there is only one CAO user group, and user IDs belonging to this group may be used to access central administration and operation functions, as per the security group they belong to. Administration and operational functions may include access and modification to one or more tables, each table storing data relating to one or more of the following functions: CAO user ID setup, CAO security group setup, global banner messages, table maintenance (reference data), event scheduling, transaction alert configuration, console configuration, transaction routing, branch setup and configuration, CSU user group setup, CSU security group setup, CSU banner messages, table maintenance (administrative data), account setup, client inquiry functions, transaction monitoring, cutoff time maintenance (in instruction processing, the backdating, forward dating and end-of-day time limits for each business product), audit trail inquiry, CU user group setup, CEU user group setup, CEU security group setup, account ownership, remote approval rules, CU security group reset, and password reset.

Within the CAO group, there may be CAO “admin” users, who can set up and maintain other CAO users, and “application” users, who can perform the functions made available to their CAO security group. The CAO user ID maintenance function is identical to the current client ID maintenance function; user IDs are assigned to an already defined security group. The CAO maintenance function allows the CAO admin user to specify which CAO functions the security group may access. In a preferred embodiment, when a security group is created, it cannot be tied to user until another CAO admin user has approved the creation of the group. Similarly, if a security group is modified by an admin user, the modifications do not take effect until approval by another admin user.

CAO users create the CSU user groups, which are the bank or financial institution business units that are primarily responsible for setting up clients and handling day-to-day support for those clients within their region or market segment. A CSU table, in a preferred embodiment of the invention, contains data regarding contact names and phone numbers, address, and/or country code. Another table, keyed by CSU code and branch code, may hold all of the branches that the CSU group may access for cutoff time maintenance, which table may be tied to the CSU table. If the CSU is not to be given access to cutoff time maintenance for any branch, then this table will have no entries in it for that CSU code.

The CSU security group maintenance function preferably allows the CAO user or CSU administrator to specify the CSU functions to which the security group has access. Since a CAO user has access to multiple CSU user groups, in operation, the CAO user must first enter the CSU group ID that will direct the security group maintenance function to the appropriate group, at which point the CAO user may access the same functions as would a CSU administrator user. In a preferred embodiment, when a security group is created, it cannot be tied to user until another entitled user has approved the creation of the group. Similarly, if a security group is modified, the modifications do not take effect until approval by another entitled user.

Once a CSU user group entry has been created using the CSU maintenance function, a CSU ID may be set up for that user group. This function may be performed by any CAO user who belongs to a CAO security group with CSU user ID setup access or an admin CSU user. Since a CAO user has access to multiple CSU user groups, in operation, the CAO user must first enter the CSU group ID that will direct the security group maintenance function to the appropriate group, at which point the CAO user may access the same functions as would a CSU administrator user. The CAO or CSU admin user may modify a password or reassign a password which has been lost or forgotten by a user, and a second CAO user would preferably be required to approve the modification or reassignment.

Before a CEU OR CU user group may be set up, the underlying enterprise code must be created. For example, if “GE” were to be set up as a CEU group, and GE UK, GE US, and GE Canada were to be set up as CU groups, then “GE” would first have to be set up as an enterprise code. In a preferred embodiment of the invention, an enterprise table comprises for each enterprise an eight-character code, a 50-character description, and a 1000 character free-form information field.

CEUs differ from normal CUs, as CEUs can set up new CUs, access the user IDs within those CU groups, and set up remote approval workflow rules within their enterprise. CEUs inherit the exact enterprise code to which they are assigned. A CEU must belong to a CSU. If a CSU user is setting up the CEU, then that CSU automatically becomes the owner. If a CAO user is setting up the enterprise, then the CAO user must select an owner CSU from the list of set up CSUs. CSU users can only access CEU groups that belong to their CSU group, for modification or deletion. A financial institution may elect to retain control over the CEU functions if a client lacks the required sophistication to manage the CEU functions, or to provide the CEU functions as a service to its clients. In this scenario, CEUs are not used, and that client or group of clients should be set up as normal CU groups.

A CU group must belong to a CSU and to an enterprise. If a CSU user is setting up the CU group, then that CSU automatically becomes the owner. If a CAO user is setting up the enterprise, then the CAO user must select an owner CSU from the list of set up CSUs. When the CU group is created, it must be assigned to an existing enterprise. CSU users can only access CU groups that belong to their CSU group, for modification or deletion.

In a preferred embodiment, CAO users have the ability to set up banners to all clients. When the banner is created, the user may specify whether a message automatically “pops up” upon logon, or whether the message remains as a minimized icon on the main window of the client's application until viewed by the client. The CAO user may send a banner message to a specific user group (CSU, CEU or CU) or to all user groups belonging to an enterprise (including the enterprise user group). CSU users have the same banner capabilities, but are limited to sending messages to their own user community.

Preferably, a table maintenance function is included for creating and maintaining bank (or other financial institution) codes. These bank codes tie together the branches that are set up for a single bank and consist of a code along with an 8- to 50-character description. Banks can only be set up by CAO users. Creating a branch mnemonic or code allows accounts to be set up against that branch. New branches can only be set up by CAO users. For every branch, the following information may be provided: bank code (the bank to which the branch belongs), branch code (the mnemonic to which an account will be assigned), branch description (the description which will appear in user reports), and detailed bank information.

BIC codes and ABA codes are set as a many-to-one relationship to branches for reporting; however, only one BIC and/or ABA can be set for a branch as the initiation code. A BIC table preferably contains the following data: bank code (the bank to which the branch belongs), branch code (the mnemonic to which an account will be assigned), BIC code (SWIFT BIC code), detailed BIC information, and initiation indicator (if set, this BIC is the only BIC for instructions, i.e. one set per branch). An ABA table preferably contains the following data: bank code (the bank to which the branch belongs), branch code (the mnemonic to which an account will be assigned), ABA code (SWIFT ABA code), detailed ABA information, and initiation indicator (if set, this ABA is the only ABA for instructions, i.e. one set per branch).

Account numbers are set up for the hub and web applications in two steps. The first step defines the account by simply associating a number to a branch code and an enterprise code. At this point, no user groups have access to it, and no transactions can be created against it. An account can belong to only one enterprise code and one branch code. Once an account has been created and the required unique enterprise and branch codes have been associated with the account, CAO, CSU and CEU user groups to allow CU ownership may access the account. Only CEU and CU user groups may own accounts.

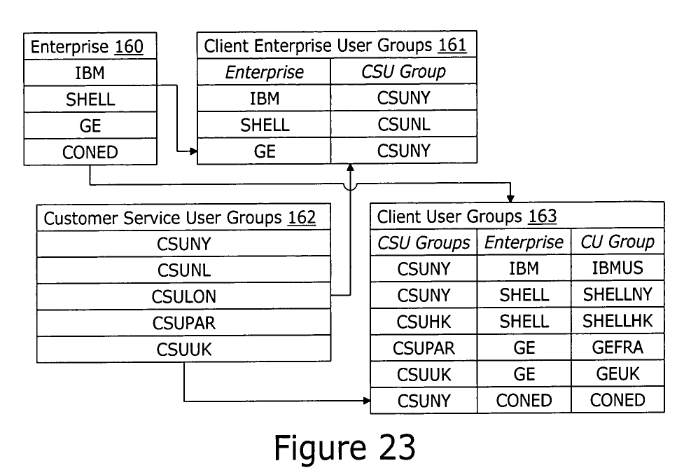

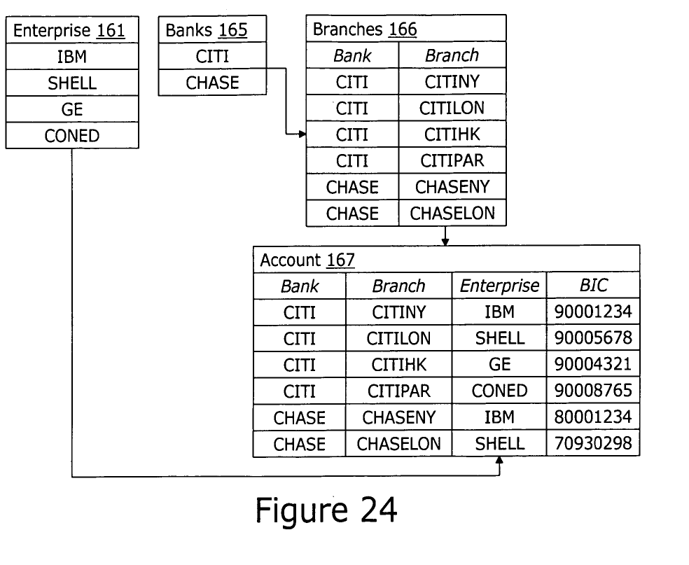

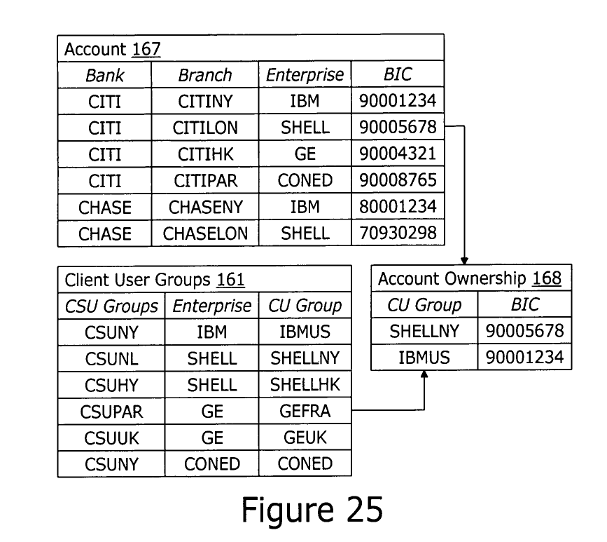

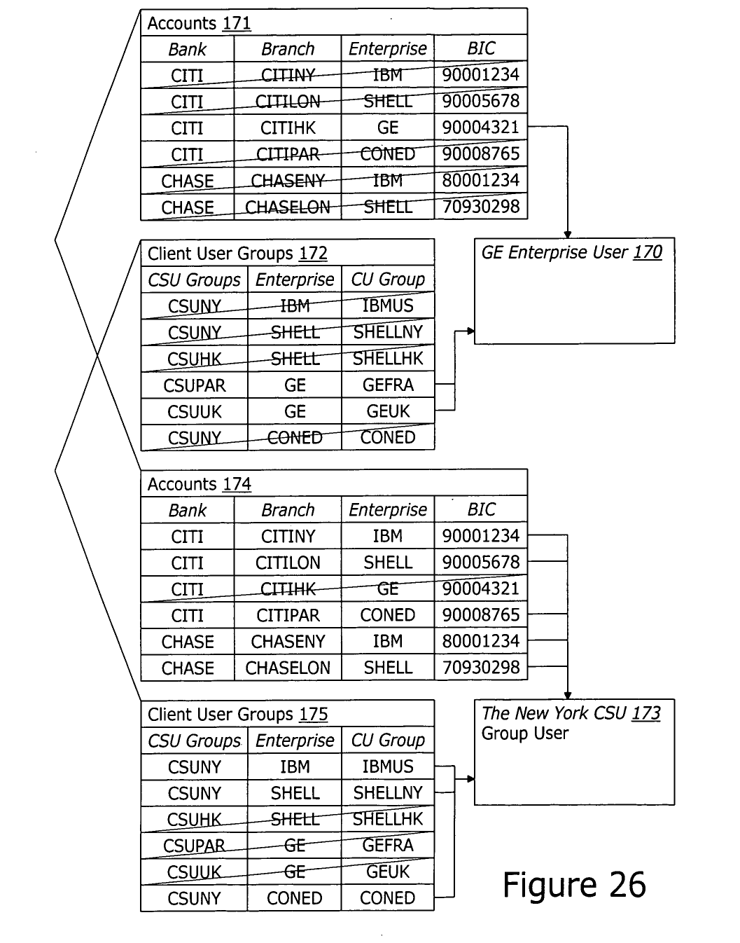

FIGS. 23-26 illustrate an exemplary user group and account configuration in one embodiment of the present invention. FIG. 23 illustrates the user group configuration in this example. Each of four customers 161 shown is represented by an exemplary enterprise code (i.e. IBM, SHELL, GE, CONED) representing a CEU. In this example, three of the CEU groups (IBM, SHELL, GE) are associated 162 with CSUs CSUNY, CSUNL, and CSUNY, respectively, which belong to a larger set of CSUs 163. The CSU groups and associated enterprises are associated 164 with CU groups IBMUS, SHELLNY, SHELLHK, GEFRA, GEUK, and CONED. FIG. 24 illustrates the account configuration in this example. Each of four customers 161 shown is represented by an exemplary enterprise code (i.e. IBM, SHELL, GE, CONED) representing a CEU. Two banks 165 are represented by bank codes CITI and CHASE. Codes for a plurality of branches are associated 166 with each of the two banks 165. BIC codes 167 are associated with the corresponding bank, branch, and enterprise. FIG. 25 illustrates the account ownership configuration in this example. The administrator draws ownership 168 from an account 167 (via the BIC reference number) and a client user group 161 (via the CU group code). Selection of accounts to the CU group is limited to those accounts linked to the same enterprise of the CU group. When a CSU user group creates account ownership records, it can only see those CEUs or CUs that belong to that CSU. User groups can only be matched to accounts if the enterprise codes match, i.e. once a user group is chosen, only accounts for that same enterprise can be associated with that user group. As FIG. 26 illustrates, when a CEU user is creating ownership records, it can only see account records and user group records belonging to that enterprise. In the example shown, a GE CEU user 170 can only see GE enterprise client user groups 171 and accounts 172. In this same example, a New York CSU 173 can only see CSUNY CSU groups 174, but can also see all accounts 175 related through those enterprises. Thus, the branch code, the account number, and the user group together embody a unique entry in the account ownership table.

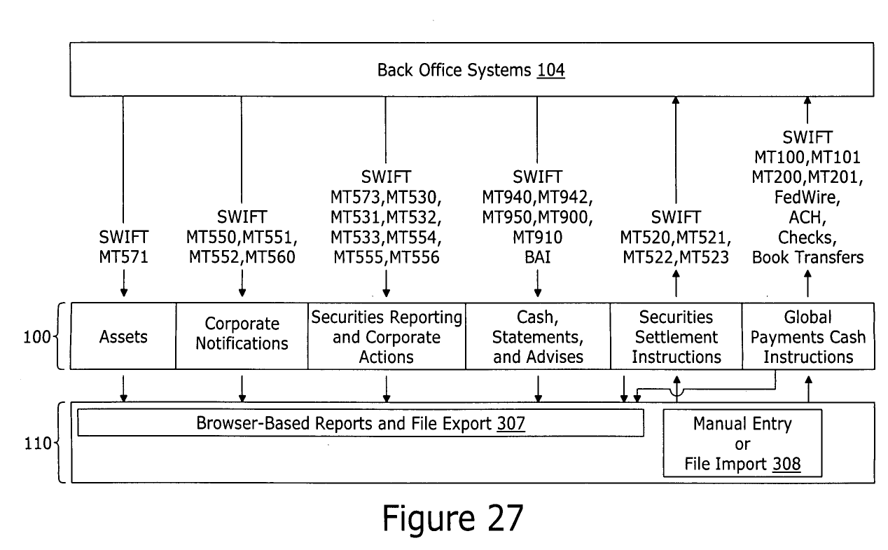

FIG. 27 is a block diagram representing useful operation of the financial transaction system 100 of FIG. 1. With reference to FIG. 1 in conjunction with FIG. 27, a client 110 may transmit instructions (in the form of financial transaction data) to the financial transaction system 100 of varying types, including: cash instructions (e.g. check, ACH, book transfer, Fed Wire, CHIP, SWIFT message), securities instructions (e.g. settlement message, instruction to custodian, cancellation), and trade finance instructions (e.g. letter of credit application, amendment, discrepancy advice, purchase order). Transactions may also include loan requests, investments, FX instructions, and/or other, non-financial instructions, such as internal system enhancement requests.

The transaction data may be in any format for which a type specific loader 139a-139c (FIG. 4) exists including NACHA, EDI (including X12), ANSI (including 810 and 820), UN/EDIFACT, SWIFT, SWIFT/ITISC, BAI, print image file, SQL-based data source, HTML, an extended markup language, a paper-based payment instrument format, a check format, a draft, a payment format, Fed Wire, PAYORD, legacy protocol, a custom format, and/or one or more of the foregoing in combination. Of course, not only are instructions transmitted and received by the financial transaction system 100, but within an embodiment of the present invention, it is understood by those skilled in the art that various instructions will also be passed back and forth internally, between the various software and/or hardware components of a financial transaction system consistent with the present invention.

The hub applications 123 provide for the financial transaction data to be entered, modified, deleted, approved, and unapproved within the application database 120 and exchanged with the back office systems 104 and other financial institution systems 114.

Ownership-Based and Validation-Based Routing on Hub Server

In a preferred embodiment of the invention, the routing may be based on one of two routing methods: ownership (i.e. what party “owns” or is associated with the data) validation (or “routing rules”, i.e. which routing rule applies based on the characteristics of the transaction).

An example of a validation rule is a rule requiring the presence of a certain data element within the message. For example, a validation rule may require the presence of a properly formatted Bank Identification Code (BIC) in the message must be present in the BIC table. A list of valid BIC codes may be stored in a BIC table—with each code representing a branch whose incoming data may be accepted and entered into the hub database.

Incoming data with either a missing or invalid BIC codes (or data that is otherwise missing a data element required for validation) is unwanted. Thus, loading rules include rules for discarding unwanted data.

The ownership rules determine the list of user groups whose members must be able to access the data of each individual message. With reference to FIG. 5 in conjunction with FIG. 1, when a message is routed, the routing queue 124 receives as many pointers to the same message as there are user groups that are to receive the message (e.g. one pointer for each user group).

An ownership rule is based on a separate ownership table 300 listing associations between user groups 301 and at least one reference table 302. An example would be an account rule, wherein the a table “account” (not shown) contains not just account numbers but also branch code and user group. A table “bank” (not shown) lists available branch codes, and the reference table containing only account numbers is implied.

The load table 146 may include fields for account number and branch code account_num and Branch_Cd, so that each message has an account number and branch code associated with it. If the table “account” mentions this combination of account number and branch code at least once, the message is routed to those and only those user groups which are associated with this pair. If the account table contains no relevant associations, the message is not routed, but instead becomes an orphan and is not loaded.

A secure e-mail function may also provided by the system 100 wherein the text of an email may be associated with the financial transaction in the application database 120.

A transaction alert system may generate an alert via fax, e-mail, or pager when one or more transactions meeting particular specified criteria occur.

Sequential Approvals

In one embodiment of the invention, a transaction may require a plurality of electronic confirmations or “signatures” (typically, three) for approval to be complete, at which point the transaction is transferred to the hub's message queues if the “transaction date” of the transaction is equal to the current date. A transaction date is the control date by which a particular business product or transaction is set to process through the back office of a financial institution. In this scenario, transactions that reached full approval prior to their transaction date are held on the application database until the current date is equal to the specified transaction date. Thus, at any time before the transaction date, a transaction can be unapproved, and then modified, deleted, or re-approved. Once a transaction has been fully approved and a predetermined cutoff time relative to the transaction date has passed, the transaction is “released” and can no longer be altered or deleted by the user. At that time, the transaction is inserted into the hub's payment message queue, and entries in the message routing table (specifying the transaction's next destination) and in the message tracking table (allowing immediate access by the hub's transaction status monitor) are created. There are three types of destinations which can be specified in the message routing table: client user group (another application user group must provide further approval based on the transaction profile, i.e. “remote approval”), bank user group (e.g. if a transaction needs repair, manual intervention, or manual interface), and host (the transaction is reformatted and sent to the appropriate system for processing).

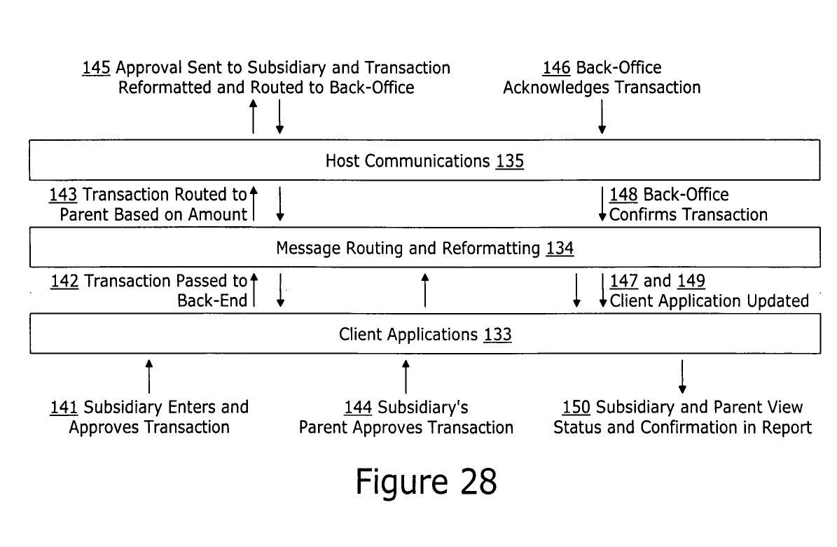

FIG. 28 illustrates the process flow for the remote approval routing phase in one embodiment of the invention, involving a subsidiary requiring transaction approval by its parent. First, the subsidiary enters and approves 141 a transaction via a client application 133. Next, the transaction is passed 142 to the back end via the message routing and reformatting mechanism 134, where it is routed 143 to its corresponding parent based on the transaction amount (or other criteria). The subsidiary's parent approves 144 the transaction via a client application 133. The approval is sent 145 to the subsidiary, and the transaction is reformatted and routed to the back office of the corresponding financial institution via host communications 135. The back office acknowledges 146 the transaction, and the client application 133 is updated 147 with the acknowledgment. The back office confirms 148 the transaction, and the client application 133 is updated 149 with the confirmation. At any time, the subsidiary and/or the parent can view 150 in real time the status of the transaction and its confirmation in a report format, on-screen, or otherwise.

When the remote approving parent approves the transaction, the subsidiary is notified with an extended status of “remote approved”, and the subsidiary will also be notified upon local approval that the transaction has been routed to another user group for further approval. Once the transaction has either been acknowledged or confirmed by the back office of the financial institution, these status updates, as well as confirmation numbers (e.g. Fed. Reference no. for a Fed Wire) will be communicated to both the parent (i.e. the remote approver) and the subsidiary (i.e. the originator). Since there are two copies of the transaction on the hub, the financial institution can track and view all of the approvers from both the parent and the subsidiary. Preferably, a transaction-tracking database is configured to track the status of a transaction throughout the routing process.

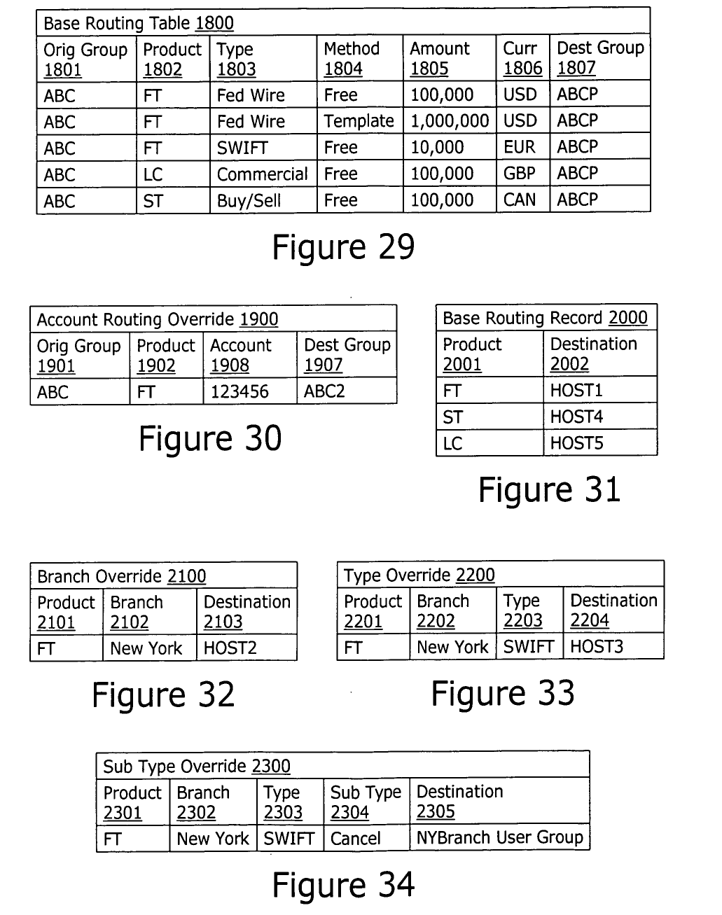

Turning now to FIG. 29, an exemplary configuration of the remote approval routing mechanism in one embodiment of the invention can be seen. The initial (or base) remote approval parameters are stored in base routing table 1800. The remote approval parameters are origination user group 1801, product 1802, transaction type 1803 (Fed Wire, SWIFT, etc.), entry method 1804 (free form, template, repetitive), monetary amount threshold 1805, currency 1806, and destination group 1807. As FIG. 30 shows, an account routing override may optionally be provided, wherein an account routing override table 1900 contains entries for origination user group. 1901, product 1802, account number 1908, and destination group 1907. In a thus configured scenario, Fed Wire and SWIFT transactions arriving from the ABC group would be selectively routed to the ABCP or ABC2 user groups for remote approval. Transaction types other than Fed Wire or SWIFT would not require any remote approval. Free form Fed Wires over 100,000 USD would require approval from either “ABC2” if the debit account number was “123456” or from “ABCP” for any other account number. Fed Wire template transactions would have a 1,000,000 USD threshold. SWIFT transactions would require remote approval if the currency being transferred exceeded a converted amount of 10,000 EUR (based on the indicative rate table). The account routing override table is applied only if a base routing record triggers remote routing, and irrespective of which base routing record corresponds to the product. There are two remote approval records for the LC (trade finance letter of credit application) and the ST (securities instruction) products. Any “commercial” (the most common type of application) letter of credit application with a face value over 100,000 GBP would be routed to the “ABCP” user group. Any buy/sell instruction with a settlement value over 100,000 CAN would also be routed to “ABCP”.

Back office routing, the second phase of the transaction routing mechanism, is executed once the first phase (remote approval) has been resolved, either by creating a new transaction that requires remote approval, or by a determination that no remote approval is needed). The parameters used in the second routing phase are product, branch, type, subtype, and destination. FIG. 31 illustrates an exemplary configuration of a base routing record table 2000 in one embodiment of the invention. Base routing record table 2000 specifies for each base routing record the appropriate routing destination 2002 corresponding to each product 2001. As can be seen in the example branch override table 2100 of FIG. 32, the appropriate routing destination 2103 for a product 2101 with a particular branch code 2102 is specified for each branch override record. FIG. 33 shows an exemplary type override table 2200, wherein the appropriate routing destination 2204 for a product 2201 with a particular branch code 2202 and transaction type 2203 is specified for each type override record. As FIG. 34 shows, subtype override table 2300 specifies the appropriate destination 2305 for a product 2301 with a particular branch code 2302, transaction type 2303 and subtype 2304. The routing tables are created on an “override basis”, i.e. if there is only one destination, one routing record is needed (e.g. all funds transfers are routed to “HOST1”). In a thus configured scenario, four separate destinations for a payment transaction arriving on the hub are specified in tables 2000, 2100, 2200, and 2300. By default, all transactions will be sent to destination “HOST1” In the format specified for that host. The first level override 2100 specifies that transactions with a branch code of “New York” be sent to host destination “HOST2”. The second 2200 and third 2300 level overrides specifically identify SWIFT type transactions, such that all “New York” SWIFT transaction types are routed to “HOST3”, except for subtype “Cancel”, which is routed to a bank browser user group “NYBranch”. Thus, all transactions with a branch code other than “New York” are routed to “HOST1” and “New York” branched transactions are routed to “HOST2”, so long as they are not SWIFT type transactions. In the foregoing example, securities (ST) and letter of credit (LC) transactions are routed to only one host, regardless of branch, type or subtype.

Audit Trail

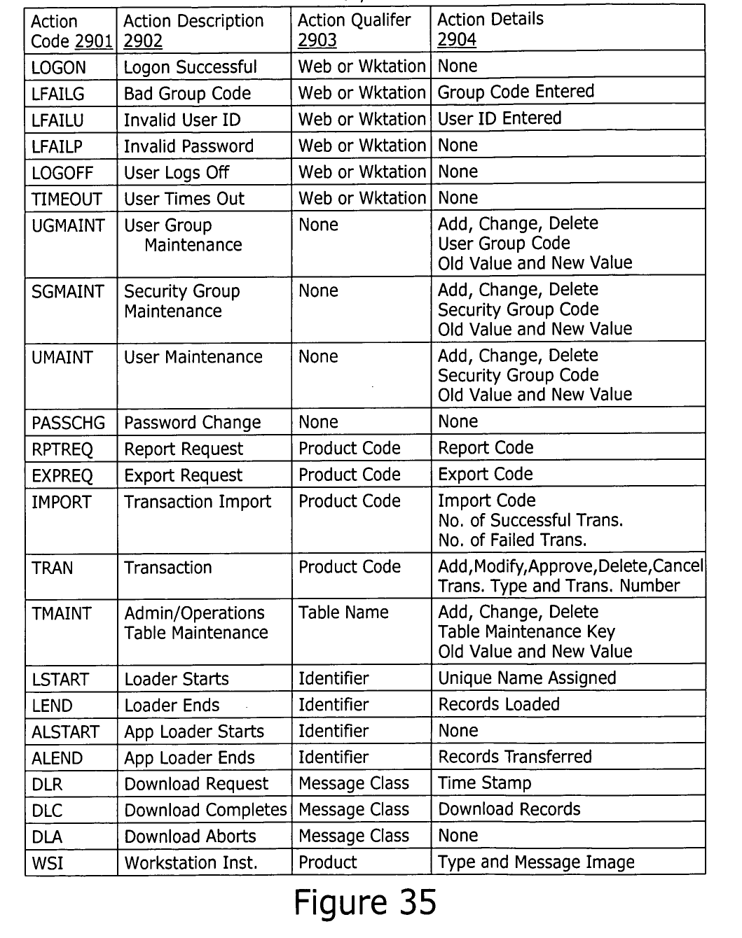

In a preferred embodiment, an audit trail log is provided, which is operable to store successful and/or unsuccessful user logon attempts, user maintenance activities, security group maintenance activities, and/or the originating IP address. One or more audit trail tables may also be provided to store some or all activity performed on the hub server, the web server, and/or the database server by web application users, as well as hub administrators and operators. An audit trail table preferably contains the following column definitions: user group (the user group logged on to perform the action), user group type (CAO, CSU, CEU or CU), user ID (the user ID logged on to perform the action), date and time of when the action occurred, action code, action qualifier, and action details. The action code, action qualifier, and action details in one embodiment of the invention are set forth in the table of FIG. 35. FIG. 35 shows for each action code the 2901 associated description of the action 2902, action qualifier 2903, and details 2904.

While the terms “hub” and “hub server” are used generally herein with reference to a particular component of a financial transaction system consistent with the present invention, these terms, as used herein, may also refer to a plurality of hardware and/or software components within a financial transaction system, including the entire financial transaction system. It should also be appreciated from the outset that one or more of the functional components may alternatively be constructed out of custom, dedicated electronic hardware and/or software, without departing from the present invention. Thus, the present invention is intended to cover all such alternatives, modifications, and equivalents as may be included within the spirit and broad scope of the invention as defined only by the hereinafter appended claims.

1. A financial transaction system for managing the exchange of financial transaction data between a client system coupled to the financial transaction system by an open network and a financial institution transaction processing system, the financial transaction system comprising:
a web server coupled to the open network for receiving a financial transaction from the client system in the user group transaction format, the financial transaction comprising a plurality of data elements and a portion of the data elements comprising sub elements;
a hub loading module for:
receiving the financial transaction in the user group transaction format;
parsing the financial transaction to a core data element format compliant with a transaction type profile corresponding to the financial transaction;
an application loading module for:
receiving the financial transaction in the core data element format; and
generating a financial transaction in an application format, the application format comprising a plurality of application data elements different than the data elements of the user group transaction format;
a hub application for;
receiving the financial transaction in the application format;
grouping the financial transaction in the application format with a plurality of other financial transactions in the application format to create a batch transaction file;
providing the batch transaction file to the financial institution transaction processing system.

2. The financial transaction system of claim 1:
further comprising a queue database associating a message with identification of a destination associated with the message;
wherein the web server writes the financial transaction in the user group format to the queue database in association with an indication that the hub loading module is the destination associated with the message;
wherein the hub loading module retrieves the financial transaction from the queue database and writes the financial transaction in the core data element format to the queue database in association with an indication that the application loading module is the destination associated with the message; and
wherein the application loading module retrieves the financial transaction in the core data element format from the queue database.

3. The financial transaction system of claim 2:
further comprising an application database comprising application specific tables for storing the financial transaction in the application format;
wherein the application loading module writes the financial transaction in the application format to the application database;
wherein the hub application builds the batch transaction file from financial transactions stored in the application database.

4. The financial transaction system of claim 3, wherein:
the application database associates, with the financial transaction, information about the processing status of the financial transaction; and
the hub application writes information about the processing status of the financial transaction to the application database upon grouping of the financial transaction into a batch transaction file.

5. The financial transaction system of claim 3, wherein the hub application:
utilizes the financial transaction data elements to generate an approval inquiry transaction related to the financial transaction, the approval inquiry transaction including only a portion of the data elements of the financial transaction and additional data elements related to approval of the financial transaction for processing;
queues the approval transaction for delivery to a member of a user group with authority to approve processing of the financial transaction;
and groups the financial transaction with a plurality of other financial transactions to create a batch transaction file for providing to the financial institution transaction processing system only after receiving an approval response transaction in response to the generated approval inquiry transaction.

6. The financial transaction of claim 5:
the application database associates, with the financial transaction, information about the processing status of the financial transaction; and
the hub application writes information about the processing status of the financial transaction to the application database upon receiving an approval response.

7. The financial transaction of claim 3:
wherein the hub application:
further receives a batch response file from the financial institution transaction processing system;
extracts a response transaction from the batch response file; and
writes the response transaction to the queue database in association with an indication of the user group and an indication that an extraction module is the destination of the response transaction; and
the system further comprises the extraction module for:
receiving the response transaction from the queue database;
generating a user group response transaction in a format associated with the response transaction type and transaction requirements of the user group;
writing the user group response transaction to the queue database in association with an indication that the user group is the destination of the response transaction; and
wherein the web server retrieves the response transaction from the queue database, populates data elements of the response transaction into a web document, and provides the web document to a client system operated by a member off the user group.

8. The financial transaction of claim 3:
wherein the hub application:
further receives a batch response file from the financial instruction transaction processing system;
extracts a response transaction from the batch response file; and
writes the response transaction to the queue database in association with an indication of the user group and an indication of an extraction module is the destination of the response transaction; and
the system further comprises the extraction module for:
receiving the response transaction from the queue database;
generating a user group response transaction in a format associate with the response transaction type and transaction requirements of the user group;
writing the user group response transaction to the queue database in association with an indication that the user group is the destination of the response transaction; and
wherein the web server retrieves the response transaction from the queue database, populates data elements of the response into a response file comprising data elements of multiple response transactions for delivery to a member of the user group, and provides the response file to a client system operated by a member off the user group.

9. A method of operating a financial transaction system for managing the exchange of financial transaction data between a client system coupled to a financial transaction system by an open network and a financial institution transaction processing system, the method comprising:
receiving a financial transaction from the client system over the open network, the financial transaction being in a user group transaction format and comprising a plurality of data elements, at least a portion of the data elements comprising sub elements;
parsing the financial transaction to a core data element format compliant with a transaction type profile corresponding to the financial transaction;
generating a financial transaction in an application format, the application format comprising a plurality of application data elements different than the data elements of the user group transaction format;
grouping the financial transaction in the application format with a plurality of other financial transactions in the application format to create a batch transaction file; and
providing the batch transaction file to the financial institution transaction processing system.

10. The method of claim 9: further comprising
writing the financial transaction received from the client system to a queue database in association with an indication that the transaction is queued for parsing to a core data element format;
retrieving financial transaction from the queue database for parsing to the core data element format;
writing the financial transaction to the queue database in association with an indication that the financial transaction, in the core data element format; is queued for loading to an application database; and
retrieving the financial transaction, in the core data element format, from the queue database for generating the financial transaction in the application format; and
writing the financial transaction, in the application format, to the application database.

11. The method of claim 10, further comprising writing information about the status of the processing of the financial transaction to the application database upon grouping of the financial transaction into a batch transaction file.

12. The method of claim 10, further comprising:
utilizing the financial transaction data elements to generate an approval inquiry transaction related to the financial transaction, the approval inquiry transaction including only a portion of the data elements of the financial transaction and additional data elements related to approval of the financial transaction for processing;
queuing the approval inquiry transaction for delivery to a member of a user group with authority to approve processing of the financial transaction; and
and the step of grouping the financial transaction with a plurality of other financial transactions to create a batch transaction file for providing to the financial institution transaction processing system is performed only after receiving an approval response transaction in response to the generated approval inquiry transaction.

13. The method of claim 12, further comprising writing information about the status of the processing of the financial transaction to the application database upon receiving an approval response transaction.

14. The method of claim 10, further comprising:
receiving a batch response file from the financial instruction transaction processing system;
extracting a response transaction from the batch response file, the response transaction being in an application format;
writing the response transaction to the queue database in association with an indication of the user group and an indication that the response transaction is queued for extraction;
receiving the response transaction from the queue database and generating a user group response transaction in a format associated with the response transaction type and transaction requirements of the user group;
writing the user group response transaction to the queue database in association with an indication that the user group response transaction is queued for delivery to the user group; and
retrieving the response transaction from the queue database, populating data elements of the response transaction into a web document, and providing the web document to a client system operated by a member off the user group.

15. The method of claim 10, further comprising:
receiving a batch response file from the financial instruction transaction processing system;
extracting a response transaction from the batch response file, the response transaction being in an application format;
writing the response transaction to the queue database in association with an indication of the user group and an indication that the response transaction is queued for extraction;
receiving the response transaction from the queue database and generating a user group response transaction in a format associated with the response transaction type and transaction requirements of the user group;
writing the user group response transaction to the queue database in association with an indication that the user group response transaction is queued for delivery to the user group; and
retrieving the response transaction from the queue database, populating data elements of the response into a response file comprising data elements of multiple response transactions for delivery to the user group, and providing the response file to a client system operated by a member off the user group.
